(19) United States
(12) Patent Application Publication
(10) Pub. No.: US 2008/0226164 A1
(43) Pub. Date: Sep. 18, 2008

(54) Image data decoding device, image data encoding device, image processing device, and electronic instrument

(75) Inventor: Atsushi Obinata, Hachioji (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 12/075,429

(22) Filed: Mar. 11, 2008

(30) Foreign Application Priority Data
Mar. 12, 2007 (JP) 2007-061759
Mar. 12, 2007 (JP) 2007-061858
Dec. 19, 2007 (JP) 2007-327199

(51) Int. Cl. G06K 9/00

(52) U.S. Cl. 382/166

(57) ABSTRACT

An image data decoding device decodes compressed image data obtained by encoding image data using a lossy compression process, the image data being subjected to a key color process that extracts a pixel of a color that coincides with a key color. The image data decoding device includes a decoding section that decompresses the compressed image data to decode the compressed image data, and a decoded data comparison section that detects whether or not a color indicated by first decoded data obtained by the decoding section coincides with the key color, when the decoded data comparison section has detected that the color indicated by the first decoded data coincides with the key color, the image data decoding device outputting second decoded data that differs from the first decoded data instead of the first decoded data.

Japanese Patent Application No. 2007-61759 filed on Mar. 12, 2007, Japanese Patent Application No. 2007-61858 filed on Mar. 12, 2007, and Japanese Patent Application No. 2007-327199 filed on Dec. 19, 2007, are hereby incorporated by reference in their entirety.

### BACKGROUND OF THE INVENTION

The present invention relates to an image data decoding device, an image data encoding device, an image processing device, an electronic instrument, and the like.

In recent years, the number of pixels of a display and the number of grayscales per pixel have been increased in order to achieve a high-definition display. This applies to a liquid crystal display device used for a portable telephone, for example. A VGA screen (480×640 dots) or a WVGA screen (480×800 dots) will be employed for portable telephones instead of a QVGA screen (240×320 dots) which is mainly used at present. A QVGA screen employs a grayscale value per pixel of 16 or 18 bits. On the other hand, a VGA or WVGA screen employs a grayscale value per pixel of 18 or 24 bits. An increase in the number of pixels and the grayscale value requires an increase in capacity of a memory which stores image data.

An increase in capacity of a memory significantly increases the cost of a driver IC including a RAM. For example, the memory area of a RAM increases by four when employing a QVGA screen instead of a VGA screen. Therefore, the area of a driver IC (driver section in a broad sense) including a RAM also increases to a large extent. In this case, a driver IC including a RAM, which is mounted on a glass substrate using a chip on glass (COG) technology, increases the area of a glass substrate of a liquid crystal display panel, whereby the number of panels which can be produced from a production substrate decreases. Moreover, the rectangular shape of a driver IC having a longitudinal axis along the short side of the glass substrate cannot be maintained. This makes it difficult to mount a driver IC using the COG technology. Therefore, it is necessary to use a chip on film (COF) technology.

Some portable telephones employ a configuration in which a liquid crystal control IC is provided between a baseband engine (LSI) and a liquid crystal driver IC in order to reduce the task of the baseband engine relating to liquid crystal display instead of a configuration in which the baseband engine directly supplies image data to the liquid crystal driver IC. However, the capacity of a memory provided in the liquid crystal control IC must be increased as the amount of image data increases.

The above problem also occurs when transferring high-definition image data between an integrated circuit (image output source) which receives or generates an image and an integrated circuit which drives a display section or a printer.

An image data compression method is classified as a loss-less compression method and a lossy compression method. According to the loss-less compression method, decompressed data is the same as data before compression. On the other hand, a process which implements loss-less compression becomes complicated, whereby an increase in circuit scale and power consumption occurs when implementing an IC. According to the lossy compression method, decompressed data differs from data before compression. However, since lossy compression is implemented by a simple process, an increase in circuit scale and power consumption when implementing an IC can be suppressed. Therefore, it is considered that the lossy compression method is suitable for IC implementation. Accordingly, it is desirable to employ the lossy compression method for the above-mentioned liquid crystal control IC.

Such a liquid crystal control IC may perform an overlay process which overlays one image on another image in order to reduce the processing load of the baseband engine. In the overlay process, a specific color is designated as a key color, and another color is displayed in a portion of the key color. However, when using the lossy compression method, the key color may be converted into image data of another color. This makes it difficult to determine the key color during the overlay process. For example, JP-A-1-112377 and JP-2001-257888 have a problem in that image data as the key color is also subjected to the lossy compression process compressing image data using the lossy compression method, thereby making it difficult for the decompression side to determine the key color.

Moreover, a pixel which is not the key color may coincide with the key color as a result of compressing the image data using the lossy compression method. According to JP-A-1-112377 and JP-2001-257888, image data as the key color is also subjected to the lossy compression process when compressing image data using the lossy compression method, and a pixel which should not be processed as the key color is processed as the key color. As a result, the image quality deteriorates.

### SUMMARY

According to one aspect of the invention, there is provided an image data decoding device that decodes compressed image data obtained by encoding image data using a lossy compression process, the image data being subjected to a key color process that extracts a pixel of a color that coincides with a key color, the image data decoding device comprising:

a decoding section that decompresses the compressed image data to decode the compressed image data; and

a decoded data comparison section that detects whether or not a color indicated by first decoded data obtained by the decoding section coincides with the key color,

when the decoded data comparison section has detected that the color indicated by the first decoded data coincides with the key color, the image data decoding device outputting second decoded data that differs from the first decoded data instead of the first decoded data.

According to another aspect of the invention, there is provided an image processing device that supplies image data to a driver section of a display panel, the image processing device comprising:

an image data encoding device that performs a lossy compression process on image data that is subjected to a key color process to generate encoded data;

a memory that stores the encoded data that has been encoded by the image data encoding device; and

the above image data decoding device that decodes the encoded data that has been stored in the memory.

According to another aspect of the invention, there is provided an electronic instrument comprising:

the above image processing device;

a driver section, image data being supplied to the driver section from the image processing device; and

a display panel that is driven by the driver section.

According to another aspect of the invention, there is provided an image data encoding device that encodes image data that is subjected to a key color process that extracts a pixel of a color that coincides with a key color, the image data encoding device comprising:

an encoding section that performs a lossy compression process on the image data to generate encoded data; and

a key color comparison section that compares a color of a pixel indicated by the image data with the key color,

the image data encoding device outputting the encoded data obtained by performing the lossy compression process on the image data when the color does not coincide with the key color, and outputting a predetermined key color code instead of the encoded data when the color coincides with the key color.

According to another aspect of the invention, there is provided an image data decoding device that decodes compressed image data obtained by encoding image data that is subjected to a key color process that extracts a pixel of a color that coincides with a key color, the image data decoding device comprising:

a key color code detection section that detects a key color code from compressed image data that includes a key color code and encoded data that is generated by a lossy compression process, the key color code being output corresponding to image data of a pixel of a color that coincides with the key color; and

a decoding section that decompresses the encoded data included in the compressed image data to decode the encoded data,

the image data decoding device outputting image data corresponding to a key color designated by the key color code as decoded data when the key color code detection section has detected the key color code, and outputting data decoded by the decoding section as the decoded data when the key color code detection section has not detected the key color code.

### BRIEF DESCRIPTION OF THE SEVERAL VIEWS OF THE DRAWING

FIG. 1 is a view schematically showing the configuration of a liquid crystal display device to which an image processing device according to one embodiment of the invention is applied.

FIG. 2 is a block diagram showing a configuration example of an image processing controller shown in FIG. 1.

FIG. 3 is a view illustrative of the operation of a compression section shown in FIG. 2.

FIGS. 4A, 4B, and 4C are views illustrative of the operation of a compression section corresponding to an image format.

FIG. 5 is a view schematically showing the configuration of a control register section shown in FIG. 2.

FIG. 6 is a block diagram showing a configuration example of a rotation processing section shown in FIG. 2.

FIG. 7 is a view illustrative of the operation of the rotation processing section shown in FIG. 6.

FIGS. 8A and 8B are views illustrative of the operation of a rotation processing section when the rotation angle is 0°.

FIGS. 9A and 9B are views illustrative of the operation of a rotation processing section when the rotation angle is 90°.

FIGS. 10A and 10B are views illustrative of the operation of a rotation processing section when the rotation angle is 180°.

FIGS. 11A and 11B are views illustrative of the operation of a rotation processing section when the rotation angle is 270°.

FIG. 12 is a block diagram showing a configuration example of a compression section shown in FIG. 2.

FIG. 13 is a view illustrative of a key color table shown in FIG. 12.

FIGS. 14A and 14B are views illustrative of a key color code generation circuit shown in FIG. 12.

FIG. 15 is a block diagram showing a configuration example of a DPCM compression circuit shown in FIG. 12.

FIG. 16 is a block diagram showing a configuration example of a DPCM encoding circuit shown in FIG. 15.

FIG. 17A is a view illustrative of a quantization table shown in FIG. 16, and FIG. 17B is a view illustrative of an inverse quantization table shown in FIG. 16.

FIG. 18 is a timing diagram showing an operation example of a pixel counter shown in FIG. 16.

FIG. 19 is a block diagram showing a configuration example of a first decompression section shown in FIG. 2.

FIG. 20 is a block diagram showing a configuration example of a DPCM decompression circuit shown in FIG. 19.

FIG. 21 is a block diagram showing a configuration example of a DPCM decoding circuit shown in FIG. 20.

FIG. 22 is a block diagram showing a configuration example of an LSB inversion circuit shown in FIG. 19.

FIG. 23 is a block diagram showing a second configuration example of a first decompression section shown in FIG. 2.

FIG. 24 is a block diagram showing a configuration example of an overlay processing section shown in FIG. 2.

FIG. 25 is a block diagram showing a configuration example of an R-component overlay processing circuit of an α-blending circuit shown in FIG. 24.

FIG. 26 is a view illustrative of the operation of a transmittance select circuit shown in FIG. 25.

FIG. 27 is a block diagram showing a configuration example of an electronic instrument according to one embodiment of the invention.

### DETAILED DESCRIPTION OF THE EMBODIMENT

Some aspects of the invention may provide an image data decoding device which can reliably prevent a situation in which image data is erroneously processed as a key color when performing a lossy compression process on the image data, an image processing device, and an electronic instrument.

Further aspects of the invention may provide an image data decoding device which enables a key color to be easily determined when performing a lossy compression process on image data, an image processing device, and an electronic instrument.

According to one embodiment of the invention, there is provided an image data decoding device that decodes compressed image data obtained by encoding image data using a lossy compression process, the image data being subjected to a key color process that extracts a pixel of a color that coincides with a key color, the image data decoding device comprising:

a decoding section that decompresses the compressed image data to decode the compressed image data; and

a decoded data comparison section that detects whether or not a color indicated by first decoded data obtained by the decoding section coincides with the key color,

when the decoded data comparison section has detected that the color indicated by the first decoded data coincides with the key color, the image data decoding device outputting second decoded data that differs from the first decoded data instead of the first decoded data.

According to this embodiment, when decoding the compressed image data obtained by encoding the image data using the lossy compression process, it is detected whether or not the color indicated by the first decoded data obtained by the decoding section coincides with the key color. When it has been detected that the color indicated by the first decoded data coincides with the key color, the second decoded data that differs from the first decoded data is output instead of the first decoded data. This reliably prevents a situation in which the image data which does not indicate the key color coincides with the key color due to the lossy compression process and is erroneously subjected to the key color process. The image obtained by the first decoded data differs from the image obtained by the second decoded data. However, when the difference between the first decoded data and the second decoded data is small, the difference between the images is observed to only a small extent. Therefore, deterioration in image quality can be suppressed.

In the image data decoding device,

the image data decoding device may further include a decoded data processing section that generates the second decoded data based on the first decoded data when the decoded data comparison section has detected that the color indicated by the first decoded data coincides with the key color,

when the first decoded data includes image data of one or more color components, the decoded data processing section may generate the second decoded data by changing image data of at least one color component selected from the image data of the one or more color components.

In the image data decoding device,

the decoded data processing section may generate the second decoded data by reversing a least significant bit of image data of at least one color component selected from the image data of the one or more color components.

According to one of the above embodiments, the second decoded data can be generated based on the first decoded data by a simple configuration.

In the image data decoding device,

the image data decoding device may further include a key color code detection section that detects a key color code from compressed image data that includes the key color code and encoded data that is generated by the lossy compression process, the key color code being output corresponding to image data of a pixel of a color that coincides with the key color,

the image data decoding device may output image data corresponding to a key color designated by the key color code as decoded data when the key color code detection section has detected the key color code, and may output data decoded by the decoding section as the decoded data when the key color code detection section has not detected the key color code.

According to this embodiment, the compressed image data which includes the key color and the encoded data is input, and the key color code is detected before decoding the encoded data. When the key color code has been detected, image data corresponding to the key color designated by the key color code is output as the decoded data. When the key color code has not been detected, the data decoded by the decoding section is output as the decoded data. Therefore, when performing the key color process on the decoded data obtained by decoding the encoded data obtained by the lossy compression process, a situation cannot be achieved in which a portion of the key color before encoding is converted into image data of another color can be reliably prevented, whereby a desired key color process. Moreover, since the lossy compression process suitable for IC implementation can be employed for the image data encoding device, IC implementation cost can be reduced.

In the image data decoding device,

the key color code may include a key color identifier code that indicates that the color of the pixel is the key color, and a key color parameter that indicates the key color.

According to this embodiment, it is possible to reliably determine whether or not the encoded data indicates the key color based on the key color identifier code, whereby the key color which should be displayed can be reliably determined based on the key color parameter.

In the image data decoding device,

image data of an input image corresponding to one scan line may be divided into a plurality of blocks, and the encoded data may be data that is obtained by compressing the image data of the input image corresponding to a block among the plurality of blocks; and

the decoding section may decode the encoded data on a block-by-block basis.

According to this embodiment, the image data is encoded and stored in the memory on a block-by-block basis, and the encoded data is decoded on a block-by-block basis. Therefore, an inexpensive image data decoding device of which the memory capacity is reduced can be provided. In this case, the compression rate decreases as compared with the case of encoding the image data corresponding to one scan line. On the other hand, the encoding process and the decoding process are completed on a block-by-block basis. Therefore, even if data in one block is replaced by another piece of data, the decoding results for other blocks are not affected. As a result, a user-friendly image data decoding device can be provided.

According to another embodiment of the invention, there is provided an image processing device that supplies image data to a driver section of a display panel, the image processing device comprising:

an image data encoding device that performs a lossy compression process on image data that is subjected to a key color process to generate encoded data;

a memory that stores the encoded data that has been encoded by the image data encoding device; and

one of the above image data decoding devices that decodes the encoded data that has been stored in the memory.

According to this embodiment, an image data decoding device can be provided which can reliably prevent a situation in which image data is erroneously processed as the key color when performing the lossy compression process on the image data.

In the image processing device,

the image data encoding device may include:

an encoding section that performs the lossy compression process on the image data to generate the encoded data; and

a key color comparison section that compares a color of the image data of the pixel with the key color,

the image data encoding device may output the encoded data obtained by performing the lossy compression process on the image data when the color of the image data does not coincide with the key color, and may output a predetermined key color code instead of the encoded data when the color of the image data coincides with the key color.

According to this embodiment, the image data of the pixel which coincides with the key color is detected for the key color process before encoding the image data using the lossy compression process. The lossy compression process is performed on the image data of the pixel which does not coincide with the key color, and the resulting encoded data is output. When the image data of the pixel coincides with the key color, the predetermined key color code is output instead of the encoded data obtained by encoding the image data. Therefore, when performing the key color process on the decoded data obtained by decoding the encoded data, a situation can be reliably prevented in which a portion of the key color before encoding is converted into image data of another color by the lossy compression process, whereby a desired key color process cannot be achieved. Moreover, since the lossy compression process suitable for IC implementation can be employed for the image processing device, IC implementation cost can be reduced.

In the image processing device,

the encoding section may encode the image data at a compression rate equal to or higher than a predetermined compression rate; and

a bit length of the key color code may be equal to or less than a number of bits that maintains the predetermined compression rate.

According to this embodiment, a compression rate equal to or higher than the predetermined compression rate ensured by the encoding section can be maintained by a simple configuration. Moreover, the decompression side can simply determine the key color code when the bit length of the key color code is fixed.

In the image processing device,

the key color code may be adjusted so that the bit length of the key color code is equal to the number of bits that maintains the predetermined compression rate by inserting dummy data into a key color parameter.

According to this embodiment, a compression rate equal to or higher than the predetermined compression rate ensured by the encoding section can be maintained by a simple configuration. Moreover, the decompression side can simply determine the key color code when the bit length of the key color code is fixed.

In the image processing device,

image data of an input image corresponding to one scan line may be divided into a plurality of blocks, and the encoding section may perform the lossy compression process on the image data on a block-by-block basis to generate the encoded data.

According to this embodiment, since the image data is encoded and stored in the memory on a block-by-block basis, an inexpensive image data encoding device of which the memory capacity is reduced can be provided. In this case, the compression rate decreases as compared with the case of encoding the image data corresponding to one scan line. On the other hand, the encoding process and the decoding process are completed on a block-by-block basis. Therefore, even if data in one block is replaced by another piece of data, the decoding results for other blocks are not affected. Therefore, the encoded data stored in the memory can be updated or read on a block-by-block basis, whereby a user-friendly image data encoding device can be provided.

In the image processing device,

the image processing device may further include a rotation processing section that performs a rotation process, the rotation process generating an image by rotating the input image by a given angle with respect to a vertical direction of the input image,

the rotation processing section may include one or more line buffers, each of the one or more line buffers storing the image data of the input image corresponding to one scan line; and

image data of the image that has been generated by the rotation process performed by the rotation processing section may be supplied to the encoding section.

According to this embodiment, since the image data is encoded on a block-by-block basis, the image data after the rotation process can be stored in the memory with a very small capacity.

According to another embodiment of the invention, there is provided an electronic instrument comprising:

one of the above image processing devices;

a driver section, image data being supplied to the driver section from the image processing device; and

a display panel that is driven by the driver section.

According to this embodiment, an electronic instrument can be provided to which an image data decoding device which can reliably prevent a situation in which image data is erroneously processed as the key color when performing the lossy compression process on the image data is applied.

According to another embodiment of the invention, there is provided an image data encoding device that encodes image data that is subjected to a key color process that extracts a pixel of a color that coincides with a key color, the image data encoding device comprising:

an encoding section that performs a lossy compression process on the image data to generate encoded data; and

a key color comparison section that compares a color of a pixel indicated by the image data with the key color,

the image data encoding device outputting the encoded data obtained by performing the lossy compression process on the image data when the color does not coincide with the key color, and outputting a predetermined key color code instead of the encoded data when the color coincides with the key color.

According to this embodiment, the image data of the pixel which coincides with the key color is detected for the key color process before encoding the image data using the lossy compression process. The lossy compression process is performed on the image data of the pixel which does not coincide with the key color, and the resulting encoded data is output. When the image data of the pixel coincides with the key color, the predetermined key color code is output instead of the encoded data obtained by encoding the image data. Therefore, when performing the key color process on the decoded data obtained by decoding the encoded data, a situation can be reliably prevented in which a portion of the key color before encoding is converted into image data of another color by the lossy compression process, whereby a desired key color process cannot be achieved. Moreover, since the lossy compression process suitable for IC implementation can be employed for the image data encoding device, IC implementation cost can be reduced.

In the image data encoding device, the key color code may include a key color identifier code that indicates that the color of the pixel is the key color, and a key color parameter that indicates the key color.

According to this embodiment, it is possible to reliably determine whether or not the encoded data indicates the key color based on the key color identifier code, whereby the key color which should be displayed can be reliably determined based on the key color parameter.

In the image data encoding device,

the encoding section may encode the image data at a compression rate equal to or higher than a predetermined compression rate; and

a bit length of the key color code may be equal to or less than a number of bits that maintains the predetermined compression rate.

According to this embodiment, a compression rate equal to or higher than the predetermined compression rate ensured by the encoding section can be maintained even if the key color code is output instead of the encoded data. Therefore, since the size of the encoded data can accurately estimated before encoding, a user-friendly image data encoding device can be provided.

In the image data encoding device,

the key color code may be adjusted so that the bit length of the key color code is equal to the number of bits that maintains the predetermined compression rate by inserting dummy data into the key color parameter.

According to this embodiment, a compression rate equal to or higher than the predetermined compression rate ensured by the encoding section can be maintained by a simple configuration. Moreover, the decompression side can simply determine the key color code when the bit length of the key color code is fixed.

In the image data encoding device,

image data of an input image corresponding to one scan line may be divided into a plurality of blocks, and the encoding section may perform the lossy compression process on the image data on a block-by-block basis to generate the encoded data.

According to this embodiment, since the image data is encoded and stored in the memory on a block-by-block basis, an inexpensive image data encoding device of which the memory capacity is reduced can be provided. In this case, the compression rate decreases as compared with the case of encoding the image data corresponding to one scan line. On the other hand, the encoding process and the decoding process are completed on a block-by-block basis. Therefore, even if data in one block is replaced by another piece of data, the decoding results for other blocks are not affected. Therefore, the encoded data stored in the memory can be updated or read on a block-by-block basis, whereby a user-friendly image data encoding device can be provided.

In the image data encoding device,

the image data encoding device may further include a rotation processing section that performs a rotation process, the rotation process generating an image by rotating the input image by a given angle with respect to a vertical direction of the input image,

the rotation processing section may include one or a plurality of line buffers, each of the one or a plurality of line buffers storing the input image of the input image corresponding to one scan line; and

image data of the image that has been generated by the rotation process performed by the rotation processing section may be supplied to the encoding section.

According to this embodiment, since the image data is encoded on a block-by-block basis, the image data after the rotation process can be stored in the memory with a very small capacity.

According to another embodiment of the invention, there is provided an image data decoding device that decodes compressed image data obtained by encoding image data that is subjected to a key color process that extracts a pixel of a color that coincides with a key color, the image data decoding device comprising:

a key color code detection section that detects a key color code from compressed image data that includes a key color code and encoded data that is generated by a lossy compression process, the key color code being output corresponding to image data of a pixel of a color that coincides with the key color; and

a decoding section that decompresses the encoded data included in the compressed image data to decode the encoded data,

the image data decoding device outputting image data corresponding to a key color designated by the key color code as decoded data when the key color code detection section has detected the key color code, and outputting data decoded by the decoding section as the decoded data when the key color code detection section has not detected the key color code.

According to this embodiment, the compressed image data which includes the key color and the encoded data is input, and the key color code is detected before decoding the encoded data. When the key color code has been detected, image data corresponding to the key color designated by the key color code is output as the decoded data. When the key color code has not been detected, the data decoded by the decoding section is output as the decoded data. Therefore, when performing the key color process on the decoded data obtained by decoding the encoded data obtained by the lossy compression process, a situation can be reliably prevented in which a portion of the key color before encoding is converted into image data of another color, whereby a desired key color process cannot be achieved. Moreover, since the lossy compression process suitable for IC implementation can be employed for the image data encoding device, IC implementation cost can be reduced.

In the image data decoding device,

the key color code may include a key color identifier code that indicates that the color of the pixel is the key color, and a key color parameter that indicates the key color.

According to this embodiment, it is possible to reliably determine whether or not the encoded data indicates the key color based on the key color identifier code, whereby the key color which should be displayed can be reliably determined based on the key color parameter.

In the image data decoding device,

image data of an input image corresponding to one scan line may be divided into a plurality of blocks, and the encoded data may be data that is obtained by compressing the image data of the input image corresponding to a block among the plurality of blocks; and

the decoding section may decode the encoded data on a block-by-block basis.

According to this embodiment, the image data is encoded and stored in the memory on a block-by-block basis, and the encoded data is decoded on a block-by-block basis. Therefore, an inexpensive image processing device of which the memory capacity is reduced can be provided. In this case, the compression rate decreases as compared with the case of encoding the image data corresponding to one scan line. On the other hand, the encoding process and the decoding process are completed on a block-by-block basis. Therefore, even if data in one block is replaced by another piece of data, the decoding results for other blocks are not affected. As a result, a user-friendly image data decoding device can be provided.

According to another embodiment of the invention, there is provided an image processing device that supplies image data to a driver section of a display panel, the image processing device comprising:

one of the above image data encoding devices;

a memory that stores the encoded data that has been encoded by the image data encoding device; and

one of the above image data decoding devices that decodes the encoded data that has been stored in the memory.

According to this embodiment, an image processing device can be provided which can easily determine the key color even when performing the lossy compression process on the image data.

According to another embodiment of the invention, there is provided an electronic instrument comprising:

the above image processing device;

a driver section, image data being supplied to the driver section from the image processing device; and

a display panel that is driven by the driver section.

According to this embodiment, an electronic instrument can be provided to which an image processing device which can easily determine the key color even when performing the lossy compression process on the image data is applied.

Embodiments of the invention are described in detail below with reference to the drawings. Note that the embodiments described below do not in any way limit the scope of the invention laid out in the claims. Note that all elements of the embodiments described below should not necessarily be taken as essential requirements for the invention.

1. Liquid Crystal Display Device

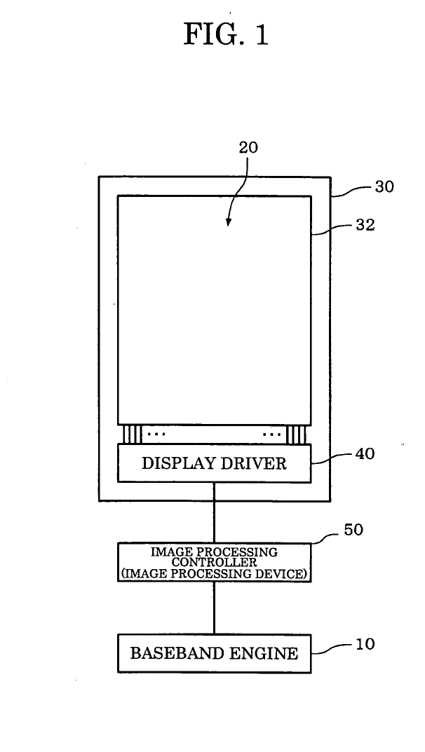

FIG. 1 shows a configuration example when applying one embodiment of the invention to a portable telephone.

In FIG. 1, a baseband engine (BBE: image supply device in a broad sense) 10 is a large scale integrated circuit (LSI) which includes a central processing unit (CPU) that controls basic functions of the portable telephone. The baseband engine 10 outputs various types of image data such as a motion picture and a still picture received via the Internet, a picture photographed using a camera, a menu screen required for operating the portable telephone, and character/graphic information such as an icon.

In FIG. 1, a liquid crystal display panel (display panel in a broad sense) 20 is provided as a display of the portable telephone. The liquid crystal display panel 20 is formed by sealing a liquid crystal between two glass substrates 30 and 32. The glass substrate 30 larger than the glass substrate 32 is an active matrix substrate, for example. A thin film transistor (TFT) (i.e., active element) is provided in each pixel. A transparent pixel electrode is connected to a drain terminal of the TFT of each pixel, a source line (data line) is connected to a source terminal of the TFT, and a gate line (scan line) is connected to a gate terminal of the TFT. A transparent electrode is provided on the glass substrate 32 opposite to the glass substrate 30. A display driver (driver section in a broad sense) 40 which drives the liquid crystal display panel 20 is mounted on the glass substrate 32 by means of COG technology along the short side of the glass substrate 30. The display driver 40 drives the liquid crystal display panel 20 by supplying a scan signal to the gate line of the liquid crystal display panel 20 and supplying a data signal to the source line of the liquid crystal display panel 20.

An image processing controller (image processing device in a broad sense) 50 is provided between the baseband engine 10 and the display driver 40. A plurality of bus lines are provided between the baseband engine 10 and the image processing controller 50 and between the image processing controller 50 and the display driver 40. Image data, horizontal/vertical synchronization signals, a clock signal, and various commands are transferred through the bus lines.

In this embodiment, the image processing controller 50 stores the image data from the baseband engine 10, performs image processing such as a rotation process or an overlay process, and supplies the processed image data to the display driver 40. The image processing controller 50 includes a memory as a compressed image data memory. The image processing controller 50 compresses (encodes) the image data from the baseband engine 10, and stores the compressed image data in the memory. The image processing controller 50 decompresses (decodes) the compressed image data read from the memory, and outputs the resulting image data to the display driver 40. This reduces the capacity of the memory.

2. Image Processing Controller

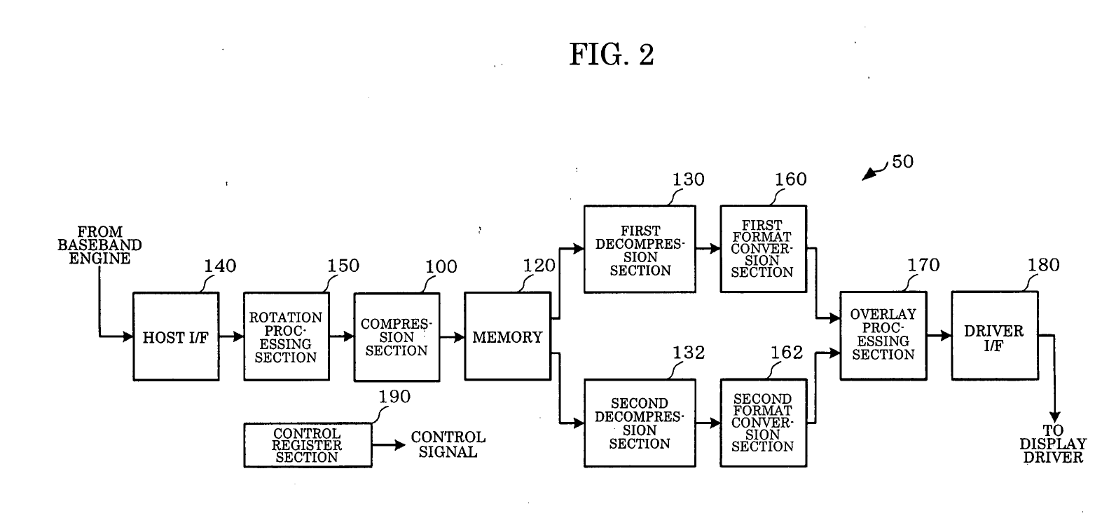

FIG. 2 is a block diagram showing a configuration example of the image processing controller 50 shown in FIG. 1.

Note that this embodiment is not limited to the configuration shown in FIG. 2. A configuration may also be employed in which at least one of the circuit blocks shown in FIG. 2 is omitted.

The image processing controller 50 functions as an image processing device which performs a key color process that extracts a pixel of a color which coincides with a key color and implements an overlay process that enables another color to be displayed on the key color. The image processing controller 50 includes a compression section 100 which functions as an image data encoding device, a memory 120 as a compressed image data memory, and first and second decompression sections (first and second decoding sections) 130 and 132 which respectively function as image data decoding devices. Although FIG. 2 shows a configuration which includes the first and second decompression sections 130 and 132, only one of the first and second decompression sections 130 and 132 may be provided. The compression section 100 as the image data encoding device may include a rotation section 150 shown in FIG. 2.

The compression section 100 compresses (encodes) the image data by means of lossy compression, and performs a key color process which extracts a pixel of a color which coincides with a predetermined key color. In this case, the compression section 100 compares the color of the pixel indicated by the compression target image data with the key color. When the color indicated by the image data does not coincide with the key color, the compression section 100 outputs the encoded data obtained by performing the lossy compression process on the image data. When the color indicated by the image data coincides with the key color, the compression section 100 outputs a predetermined key color code instead of the encoded data. The key color code may include a key color identifier code (ID) which indicates that the color of the pixel is the key color, and a key color parameter which indicates the key color. Therefore, the first and second decompression sections 130 and 132 can reliably determine whether or not the encoded data indicates the key color based on key color ID when reading the encoded data from the memory 120, whereby the key color which should be displayed can be reliably determined based on the key color parameter.

The compression section 100 divides the image data (image data of input image) from the baseband engine 10 corresponding to one scan line (one horizontal scan) into a plurality of blocks, and encodes the image data on a block-by-block basis. Specifically, the compression section 100 ensures that the image data corresponding to one screen (one frame) is encoded by compression at a compression rate equal to or higher than a predetermined compression rate (e.g. 50%). It is desirable that the compression section 100 ensure the data size of the compressed image data corresponding to one screen by encoding the image data corresponding to one scan line at a compression rate equal to or higher than a predetermined compression rate. For example, when compressing the image data at a compression rate equal to or higher than a predetermined compression rate of 50%, the data size after compression is reduced by 50% or less as compared with the data size before compression. The expression “ensures the data size” means that the process is performed so that the maximum data size after compression is equal to or less than the data size when encoding the image data at a predetermined compression rate.

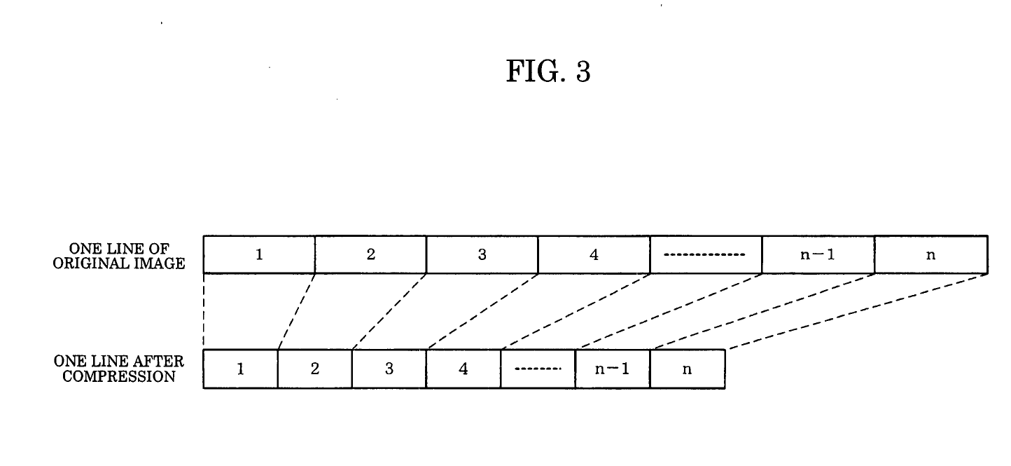

FIG. 3 is a view illustrative of the operation of the compression section 100 shown in FIG. 2.

The compression section 100 divides the image data of the original image corresponding to one scan line into n (n is an integer equal to or larger than two) blocks. The length (bit length, data length, or data size) of each block may be a fixed bit length or an arbitrary bit length. The length of each block may differ depending on the format of the image data of the input image from the baseband engine 10.

The compression section 100 compresses the image data on a block-by-block basis to generate encoded data. Therefore, the compression rate decreases as compared with the case of compressing the image data corresponding to one scan line. On the other hand, the compression process and the decompression process are completed on a block-by-block basis. Specifically, even if data in one block is replaced by another piece of data, the decompression results for other blocks are not affected. Therefore, even if the image data corresponding to one screen is compressed and stored in the memory 120, the data can be written (updated) or read on a block-by-block basis. In this case, it is desirable that the data length of one block be the data size of 8×m (m is a natural number) pixels in order to simplify the processes of the baseband engine 10 and the image processing controller 50.

The invention is not limited to the lossy compression algorithm of the compression section 100. Note that it is desirable that the compression algorithm be the following simple algorithm suitable for LSI implementation.

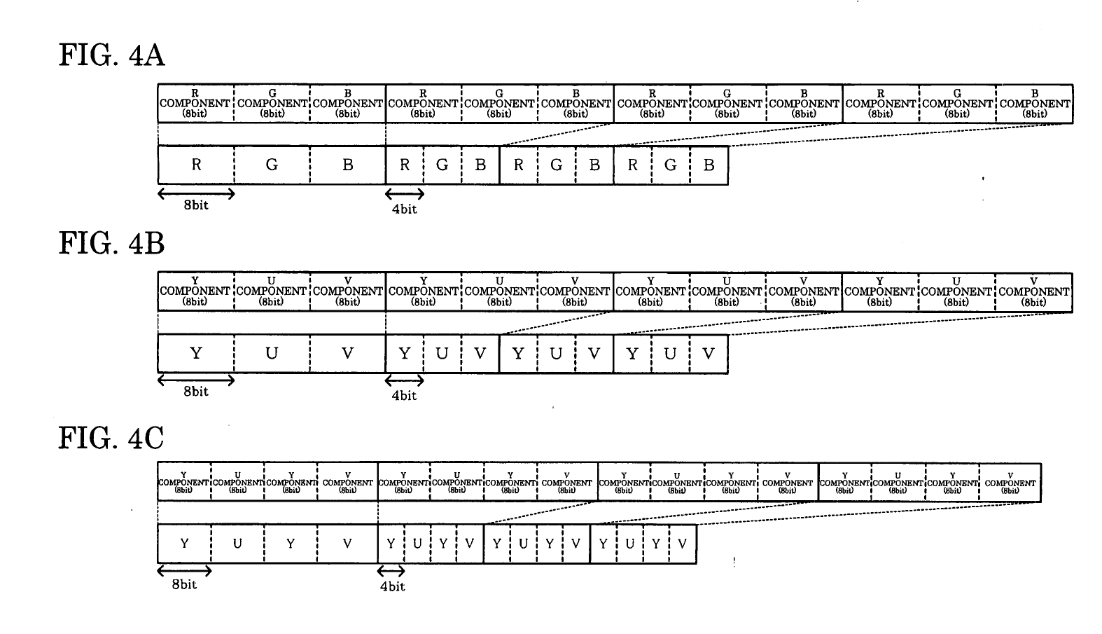

FIGS. 4A, 4B, and 4C show an operation example of the compression section 100.

The following description is given taking an example in which a differential pulse code modulation (DPCM) encoding algorithm that subjects the difference between adjacent pixels to pulse code modulation (PCM) encoding is employed as the lossy compression algorithm of the compression section 100.

FIG. 4A shows an example in which the compression section 100 encodes RGB888 format image data by DPCM encoding in units of four pixels. Therefore, the image data of each color component is 8 bits, and the image data of one pixel is 24 bits.

In this case, the compression section 100 does not compress the image data of the first pixel and directly outputs the data as encoded data. The compression section 100 calculates the difference between the image data of the first pixel and the image data of the second pixel, and converts the difference into 4-bit data. Regarding the third and fourth pixels, the compression section 100 calculates the difference from the data obtained by decompressing the preceding encoded data, and converts the difference into 4-bit data. Therefore, the image data of the second to fourth pixels is compressed by 50%. In FIG. 4A, the predetermined compression rate (worst compression rate) is 62.5%(=((8+4×3)×3)/(24×3)).

FIG. 4B shows an example in which the compression section 100 encodes YUV444 format image data by DPCM encoding in units of four pixels. Therefore, the image data of the luminance component and the color difference components of each pixel is 8 bits, and the image data of one pixel is 24 bits.

In this case, the compression section 100 does not compress the image data of the first pixel and directly outputs the data as encoded data. The compression section 100 calculates the difference between the image data of the first pixel and the image data of the second pixel, and converts the difference into 4-bit data. Regarding 1O the third and fourth pixels, the compression section 100 calculates the difference from the data obtained by decompressing the preceding encoded data, and converts the difference into 4-bit data. Therefore, the image data of the second to fourth pixels is compressed by 50%. In FIG. 4B, the predetermined compression rate (worst compression rate) is 62.5%(=((8+4×3)×3)/(24×3)).

FIG. 4C shows an example in which the compression section 100 encodes YUV422 format image data by DPCM encoding in units of eight pixels. Therefore, the image data of each pixel is 16 bits.

In this case, the compression section 100 does not compress the image data of the first and second pixels and directly outputs the data as encoded data. Regarding the third to eighth pixels, the compression section 100 calculates the difference from the data obtained by decompressing the preceding encoded data, and converts the difference into 4-bit data. Therefore, the image data of the third to eighth pixels is compressed by 50%. In FIG. 4C, the predetermined compression rate (worst compression rate) is 62.5%(=((16+2+4×2×6)/(26×8)).

As described above, the data length of one block obtained by DPCM encoding differs depending on the image format. When the image format of the image from the baseband engine 10 has been determined, the maximum value (worst value) of the size of the image data after compression can be calculated by employing the DPCM encoding algorithm. Therefore, the size of the area which must be allocated in the memory 120 is determined in advance, whereby a user-friendly image processing controller can be provided. Specifically, when using a high-encoding-rate algorithm such as the Joint Photographic Experts Group (JPEG) algorithm, the data size after compression cannot be determined until the image data corresponding to one screen is completely compressed.

Again referring to FIG. 2, the memory 120 stores the encoded data of which the data size has been reduced (compressed) by the compression section 100.

The first and second decompression sections 130 and 132 synchronously or asynchronously read the encoded data from the memory 120. Each decompression section decompresses the encoded data on a block-by-block basis (i.e., in compression units) in accordance with a decompression algorithm corresponding to the lossy compression algorithm of the compression section 100. Each decompression section detects a key color code from the data (compressed image data) read from the memory 120 in which the key color code and the encoded data are contained, and decompresses and decodes the encoded data. When the key color code has been detected, each decompression section outputs image data corresponding to the key color designated by the key color code as the decoded data. When the key color code has not been detected, each decompression section directly outputs the decoded data.

Each decompression section detects whether or not the color indicated by the first decoded data coincides with the key color. When each decompression section has detected that the color indicated by the first decoded data coincides with the key color, each decompression section outputs second decoded data differing from the first decoded data instead of the first decoded data. The decompressed image data is supplied to the display driver 40. This reliably prevents a situation in which a key color process is erroneously performed although the image obtained by causing the display driver 40 to drive the liquid crystal display panel 20 based on the first decoded data differs from the image obtained by causing the display driver 40 to drive the liquid crystal display panel 20 based on the second decoded data. When the difference between the first decoded data and the second decoded data is small, the difference in image displayed on the liquid crystal display panel 20 is observed to only a small extent. Therefore, deterioration in image quality can be suppressed.

In this embodiment, a rotation process or an overlay process can be performed on the image data supplied to the display driver 40. As shown in FIG. 2, the image processing controller 50 may include a host interface (hereinafter abbreviated as “I/F”) 140, a rotation processing section 150, first and second format conversion sections 160 and 162, an overlay processing section 170, a driver I/F 180, and a control register section 190.

The host I/F 140 interfaces a signal which is input/output through the bus line connected to the baseband engine 10.

The rotation processing section 150 generates an image by rotating the image supplied from the baseband engine 10 by a given rotation angle with respect to the vertical direction of the image, for example. The rotation processing section 150 includes a plurality of line buffers. Each line buffer stores the image data of the input image from the baseband engine 10 corresponding to one scan line. In this embodiment, since the compression section 100 performs the compression process on a block-by-block basis, as described above, the rotation processing section 150 can implement the rotation process with a reduced number of line buffers. The image data of the image subjected to the rotation process performed by the rotation processing section 150 is supplied to the compression section 100.

The first format conversion section 160 converts the format of the image data decompressed by the first decompression section 130. When directly supplying the image data from the baseband engine 10 to the display driver 40 without converting the format of the image data, the process of the first format conversion section 160 may be disabled.

The second format conversion section 162 converts the format of the image data decompressed by the second decompression section 132. When directly supplying the image data from the baseband engine 10 to the display driver 40 without converting the format of the image data, the process of the second format conversion section 162 may be disabled.

The overlay processing section 170 performs an overlay process on the image data output from the first and second format conversion sections 160 and 162. In FIG. 2, the image processing controller 50 may have a configuration in which the second decompression section 132, the second format conversion section 162, and the overlay processing section 170 are omitted.

The driver I/F 180 interfaces a signal input/output through the bus line connected to the display driver 40. For example, the driver I/F 180 outputs the image data of the image subjected to the overlay process by the overlay processing section 170 to the display driver 40 through the bus line.

The control register section 190 includes a plurality of control registers. Each control register can be accessed from the baseband engine 10. A control signal corresponding to the data set in each control register is output from the control register section 190. Each control signal is supplied to each section of the image processing controller 50. Each section of the image processing controller 50 is controlled based on the control signal from the control register section 190. Therefore, the baseband engine 10 can control each section of the image processing controller 50 by setting data in the control register of the control register section 190.

When the capacity of each of the line buffers of the rotation processing section 150 is LB bits, the number of pixels of the input image corresponding to one scan line is referred to as H, and the number of bits of the input image per pixel is referred to as P, the data length of one block (i.e., compression unit) may be a value equal to or less than f(LB/H/P) (where the function f indicates rounding off to the nearest whole number).

According to this configuration, since the image data is compressed while effectively utilizing the capacity of the line buffer to a maximum extent, the capacity of the line buffer of the rotation processing section 150 can be minimized.

When the compression section 100 encodes the image data of the input image at a compression rate equal to or higher than a predetermined compression rate W, the bit width (access unit) of the memory 120 is referred to as B, and the number of bits of the input image per pixel is referred to as P, the data length of one block (i.e., compression unit) may be a value equal to or less than f(B/W/P) (where the function f indicates rounding off to the nearest whole number).

This reduces the number of accesses to the memory 120, whereby the compression process can be performed quickly even if the screen size increases. Therefore, an increase in capacity of the memory 120 can be suppressed.

Each section of the image processing controller 50 shown in FIG. 2 is described below.

2.1 Control Register Section

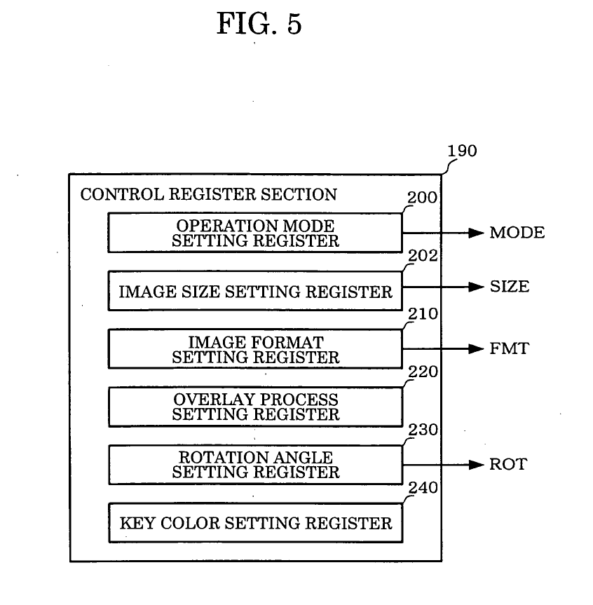

FIG. 5 schematically shows the configuration of the control register section shown in FIG. 2.

The control register section 190 includes an operation mode setting register 200, an image size setting register 202, an image format setting register 210, an overlay process setting register 220, a rotation angle setting register 230, and a key color setting register 240.

Setting data (control data) which sets the operation mode of the image processing controller 50 is set in the operation mode setting register 200. A control signal MODE corresponding to the setting data is output from the operation mode setting register 200. The image processing controller 50 can operate in a line mode (first operation mode) or a partial mode (second operation mode), for example.

The image processing controller 50 set in the line mode causes the compression section 100 to perform the compression process in scan line units, and causes the first and second decompression sections 130 and 132 to perform the decompression process in scan line units. The line mode is not suitable for the rotation process since a buffer for one screen is needed when rotating the image from the baseband engine 10. On the other hand, the data size of the compressed image data corresponding to one scan line can be reduced as compared with the partial mode.

The image processing controller 50 set in the partial mode causes the compression section 100 to perform the compression process on a block-by-block basis, and causes the first and second decompression sections 130 and 132 to perform the decompression process on a block-by-block basis. In the partial mode, the data size after compression increases as compared with the line mode. On the other hand, the partial mode enables the image from the baseband engine 10 to be rotated, only necessary data to be read from the memory 120, or only necessary data stored in the memory 120 to be updated.

Setting data corresponding to the size of the image from the baseband engine 10 in the horizontal scan direction of the image and the vertical scan direction is set in the image size setting register 202. A control signal SIZE corresponding to the setting data is output from the image size setting register 202. The image processing controller 50 determines the data size corresponding to one scan line and the number of scan lines based on the setting data set in the image size setting register 202.

Setting data corresponding to the format of the image data of the image from the baseband engine 10 is set in the image format setting register 210. A control signal FMT corresponding to the setting data is output from the image format setting register 210. The image processing controller 50 performs the compression process while changing the data size of one block, as shown in FIGS. 4A to 4C, corresponding to the image format designated using the image format setting register 210. The first and second format conversion sections 160 and 162 convert the image data into RGB888 format image data specified in advance for the display driver 40 corresponding to the image format designated using the image format setting register 210.

A transmittance associated with each of a plurality of key colors set in the key color setting register 240 is set in the overlay process setting register 220. The overlay processing section 170 performs the overlay process on the image data output from the first and second format conversion sections 160 and 162 using the transmittance set in the overlay process setting register 220. Specifically, when the color of the image coincides with one of the key colors, the overlay processing section 170 performs the overlay process on two images using the transmittance corresponding to the key color.

Setting data corresponding to an angle by which the image from the baseband engine 10 is rotated with respect to the vertical direction of the image (e.g., around the center position of the image) is set in the rotation angle setting register 230. A control signal ROT corresponding to the setting data is output from the rotation angle setting register 230. In this embodiment, setting data corresponding to a rotation angle of 0°, 90°, 180°, or 270° counterclockwise (left direction) with respect to the vertical direction of the image from the baseband engine 10 around the center position of the image is set in the rotation angle setting register 230. The rotation processing section 150 performs the rotation process based on the setting data set in the rotation angle setting register 230.

Setting data which designates a plurality of key colors for the image data of the image from the baseband engine 10 is set in the key color setting register 240. The following embodiment illustrates an example in which 16 key colors can be set. Therefore, a key color parameter which indicates the key color with which the color of the image coincides contains at least 4-bit data.

2.2 Rotation Processing Section

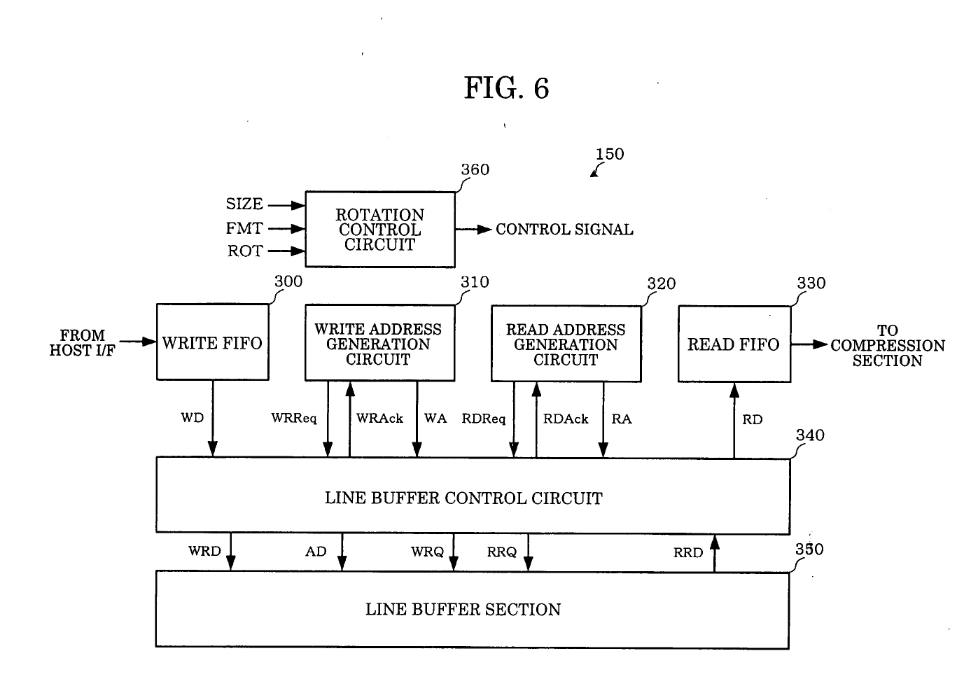

FIG. 6 is a block diagram showing a configuration example of the rotation processing section 150 shown in FIG. 2.

The rotation processing section 150 includes a write First-In First-Out (FIFO) 300, a write address generation circuit 310, a read address generation circuit 320, a read FIFO 330, a line buffer control circuit 340, a line buffer section 350, and a rotation control circuit 360.

The line buffer section 350 includes a plurality of line buffers which can store at least image data corresponding to scan lines in the same number as the number of pixels corresponding to one block (i.e., compression unit of the compression section 100). For example, when one block is in units of four or eight pixels, the line buffer section 350 includes line buffers corresponding to eight scan lines (maximum value). When one block is in units of four pixels, the line buffer section 350 includes line buffers corresponding to four scan lines. Therefore, the line buffer section 350 need not include line buffers which can store image data corresponding to one screen.

The image data from the host I/F 140 is sequentially stored in the write FIFO 300 in an input image raster scan direction.

An address is allocated to an access area of each line buffer included in the line buffer section 350. The write address generation circuit 310 generates an address WA of a data write area of the storage area of the line buffer section 350. The write address generation circuit 310 outputs a write request WRReq and the write address WA to the line buffer control circuit 340, and receives a write acknowledgment WRAck from the line buffer control circuit 340 to determine that the write request WRReq has been accepted by the line buffer control circuit 340.

The read address generation circuit 320 generates an address RA of a data read area of the storage area of the line buffer section 350. The read address generation circuit 320 outputs a read request RDReq and the read address RA to the line buffer control circuit 340, and receives a read acknowledgment RDAck from the line buffer control circuit 340 to determine that the read request RDReq has been accepted by the line buffer control circuit 340.

The line buffer control circuit 340 arbitrates between the write request WRReq from the write address generation circuit 310 and the read request RDReq from the read address generation circuit 320. When the line buffer control circuit 340 has accepted the write request WRReq as a result of arbitration, the line buffer control circuit 340 outputs the write acknowledgment WRAck to the write address generation circuit 310. The line buffer control circuit 340 outputs a write request WRQ to the line buffer section 350. The line buffer control circuit 340 outputs an address AD to the line buffer section 350 using the write address WA from the write address generation circuit 310, and outputs data WD read from the write FIFO 300 to the line buffer section 350 as write data WRD. When the line buffer control circuit 340 has accepted the read request RDReq as a result of arbitration, the line buffer control circuit 340 outputs the read acknowledgment RDAck to the read address generation circuit 320. The line buffer control circuit 340 outputs a read request RRQ to the line buffer section 350. The line buffer control circuit 340 outputs the address AD to the line buffer section 350 using the read address RA from the read address generation circuit 320, and acquires read data RRD from the line buffer section 350. The read data RRD is stored in the read FIFO 330 as data RD, and is sequentially read from the compression section 100.

The rotation control circuit 360 receives the control signals FMT, SIZE, and ROT, and generates a control signal. The control signal is used to control each section of the rotation processing section 150 shown in FIG. 6. The rotation control circuit 360 determines the data size corresponding to one scan line and the number of scan lines based on the control signals FMT and SIZE. The rotation control circuit 360 determines the rotation angle based on the control signal ROT, and the read address generation circuit 320 generates the read address RA corresponding to the rotation angle.

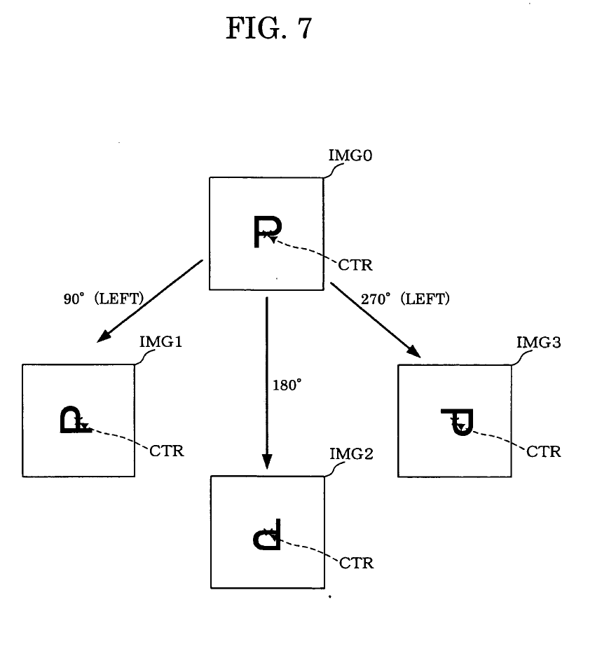

FIG. 7 is a view illustrative of the operation of the rotation processing section 150 shown in FIG. 6.

The rotation processing section 150 rotates an input image IMG0 (original image) from the baseband engine 10 corresponding to a rotation angle around a rotation axis which passes through a center position CTR of the original image.

When the setting data set in the rotation angle setting register 230 of the control register section 190 corresponds to a rotation angle of 90°, the rotation processing section 150 stores the image data in the memory 120 so that an image IMG1 is formed based on the image data supplied to the display driver 40. When the setting data set in the rotation angle setting register 230 corresponds to a rotation angle of 180°, the rotation processing section 150 stores the image data in the memory 120 so that an image IMG2 is formed based on the image data supplied to the display driver 40. When the setting data set in the rotation angle setting register 230 corresponds to a rotation angle of 270°, the rotation processing section 150 stores the image data in the memory 120 so that an image IMG3 is formed based on the image data supplied to the display driver 40.

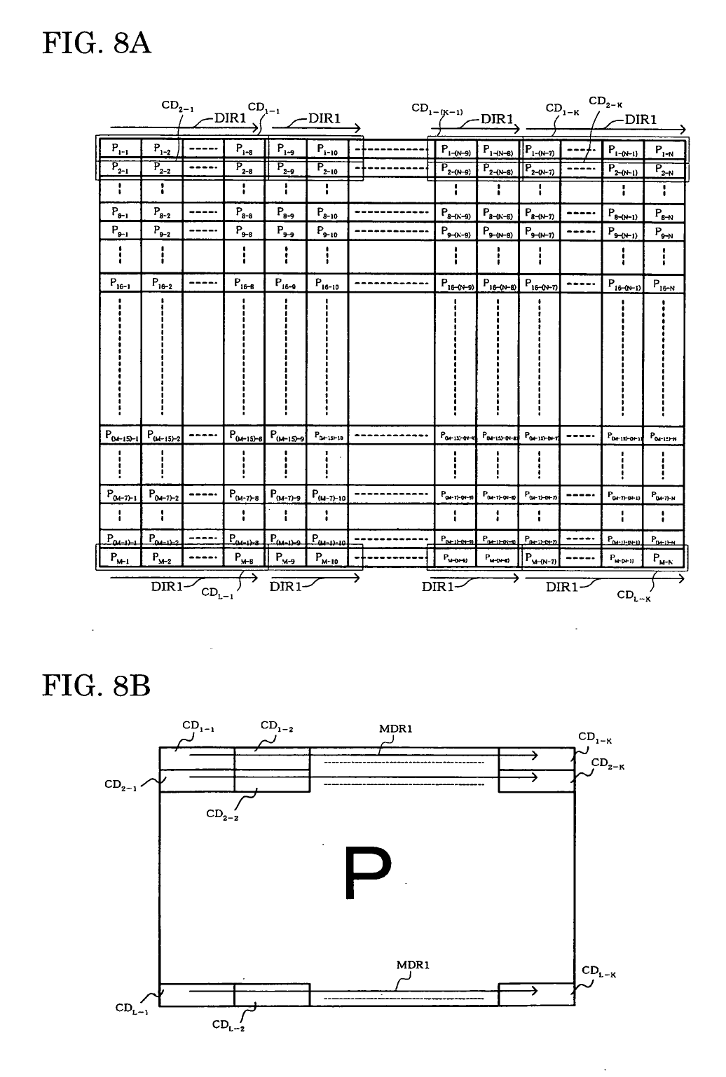

FIGS. 8A and 8B are views illustrative of the operation of the rotation processing section 150 when the rotation angle is 0°.

FIG. 8A is a view showing the input image IMG0 shown in FIG. 7 in which the image data is arranged in pixel units. In FIG. 8A, N (N is an integer equal to or larger than two) pixels are arranged in the horizontal scan direction of the input image IMG0, and M (M is an integer equal to or larger than two) pixels are arranged in the vertical scan direction of the input image IMG0. Pixels P₁₋₁, P₁₋₂, . . . , P_{1-N} are arranged in the horizontal scan direction of the input image IMG0, and pixels P₁₋₁, P₂₋₁, . . . , P_{M-1} are arranged in the vertical scan direction of the input image IMG0.

FIG. 8B schematically shows a state in which the image data after the rotation process (rotation angle: 0°) is stored in the memory 120.

In this example, the compression section 100 performs the compression process in eight pixel units. In FIG. 8A, the pixels P₁₋₁ to P₁₋₈ are compressed as shown in FIG. 4C in a direction DIR1 to generate encoded data CD₁₋₁, for example. Likewise, the pixels P₁₋₉ to P₁₋₁₆, the pixels P₁₋₁₇ to P₁₋₂₄, . . . , the pixels P_{1-(N-7)} to P_{1-N}, the pixels P₂₋₁ to P₂₋₈, . . . , the pixels P_{2-(N-7)} to P_{2-N}, . . . , the pixels P_{M-1} to P_{M-8}, . . . , and the pixels P_{M-(N-7)} to P_{M-N} are compressed in the direction DIR1 to generate encoded data CD₁₋₂, CD₁₋₃, . . . , CD_{1-K} (K is a natural number), CD₂₋₁, . . . , CD_{2-K}, . . . , CD_{L-1} (L is a natural number), . . . , and CD_{L-K}.

The encoded data thus generated is stored in the memory 120 in an order MDR1 shown in FIG. 8B. Specifically, the encoded data CD₁₋₁ to CD_{1-K} is stored in the memory 120 in the order MDR1, and the encoded data CD₂₋₁ to CD_{2-K} is then stored in the memory 120 in the order MDR1. The write address generation circuit 310 generates the write address of the line buffer section 350 so that the compression process is performed in the order shown in FIG. 8B.

As a result, it suffices that the first and second decompression sections 130 and 132 read the encoded data from the memory 120 in a raster scan direction. Specifically, the read address generation circuit 320 generates the read address of the line buffer section 350 so that encoded data CD₁₋₁, CD₁₋₂, . . . , CD_{1-K}, CD₂₋₁, CD₂₋₂, . . . , CD_{2-K}, . . . , CD_{L-1}, . . . , and CD_{L-K} is read in that order, and the decompression process is sequentially performed on the encoded data, whereby the image data of the image IMG0 when the rotation angle is 0° can be output.

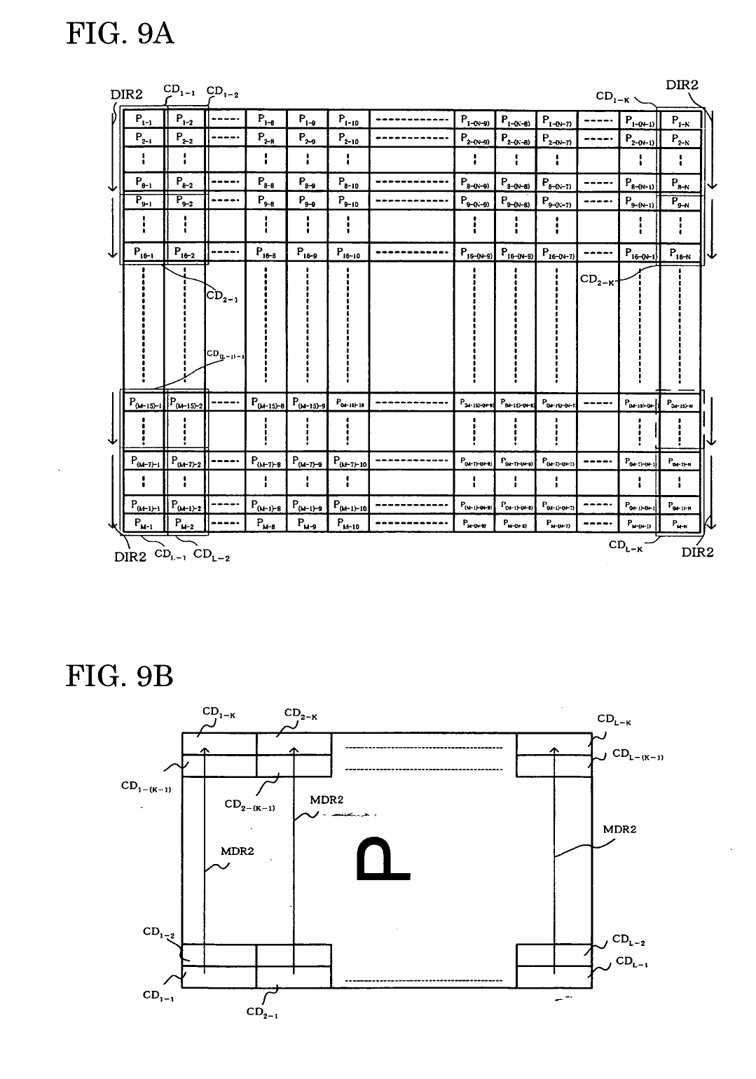

FIGS. 9A and 9B are views illustrative of the operation of the rotation processing section 150 when the rotation angle is 90°.

FIG. 9A is a view showing the input image IMG0 shown in FIG. 7 in which the image data is arranged in pixel units. In FIG. 9A, N pixels are arranged in the horizontal scan direction of the input image IMG0, and M pixel are arranged in the vertical scan direction of the input image IMG0. Pixels P₁₋₁, P₁₋₂, . . . , P_{1-N} are arranged in the horizontal scan direction of the input image IMG0, and pixels P₁₋₁, P₂₋₁, . . . , P_{M-1} are arranged on the left end in the vertical scan direction of the input image IMG0, for example.

FIG. 9B schematically shows a state in which the image data after the rotation process (rotation angle: 90°) is stored in the memory 120.

In this example, the compression section 100 performs the compression process in eight pixel units. In FIG. 9A, the pixels P₁₋₁ to P₁₋₈ are compressed as shown in FIG. 4C in a direction DIR2 to generate encoded data CD₁₋₁, for example. Likewise, the pixels P₁₋₂ to P₈₋₂, the pixels P₁₋₃ to P₈₋₃, . . . , the pixels P_{1-N} to P_{8-N}, the pixels P₉₋₁ to P₁₆₋₁, . . . , the pixels P₉₋₂ to P₁₆₋₂, . . . , the pixels P_{9-N} to P_{16-N}, . . . , the pixels P_{M-(N-7)-1} to P_{M-1}, . . . , and the pixels P_{(M-7)-N} to P_{M-N} are compressed in the direction DIR2 to generate encoded data CD₁₋₂, CD₁₋₃, . . . , CD_{1-K}, CD₂₋₁, CD₂₋₂, . . . , CD_{2-K}, . . . , CD_{L-1}, . . . , and CD_{L-K}.

The encoded data thus generated is stored in the memory 120 in an order MDR2 shown in FIG. 9B. Specifically, the encoded data CD₁₋₁ to CD_{1-K} is stored in the memory 120 in the order MDR2, and the encoded data CD₂₋₁ to CD_{2-K} is then stored in the memory 120 in the order MDR2. The write address generation circuit 310 generates the write address of the line buffer section 350 so that the compression process is performed in the order shown in FIG. 9B.

As a result, it suffices that the first and second decompression sections 130 and 132 read the encoded data from the memory 120 in a raster scan direction. Specifically, the read address generation circuit 320 generates the read address of the line buffer section 350 so that encoded data CD_{1-K}, CD_{2-K}, . . . , CD_{L-K}, CD_{1-(K-1)}, CD_{2-(K-1)}, . . . , CD_{L-(K-1)}, . . . , CD_{1-L}, . . . , and CD_{L-1} is read in that order, and the decompression process is sequentially performed on the encoded data, whereby the image data of the image IMG1 when the rotation angle is 90° can be output.

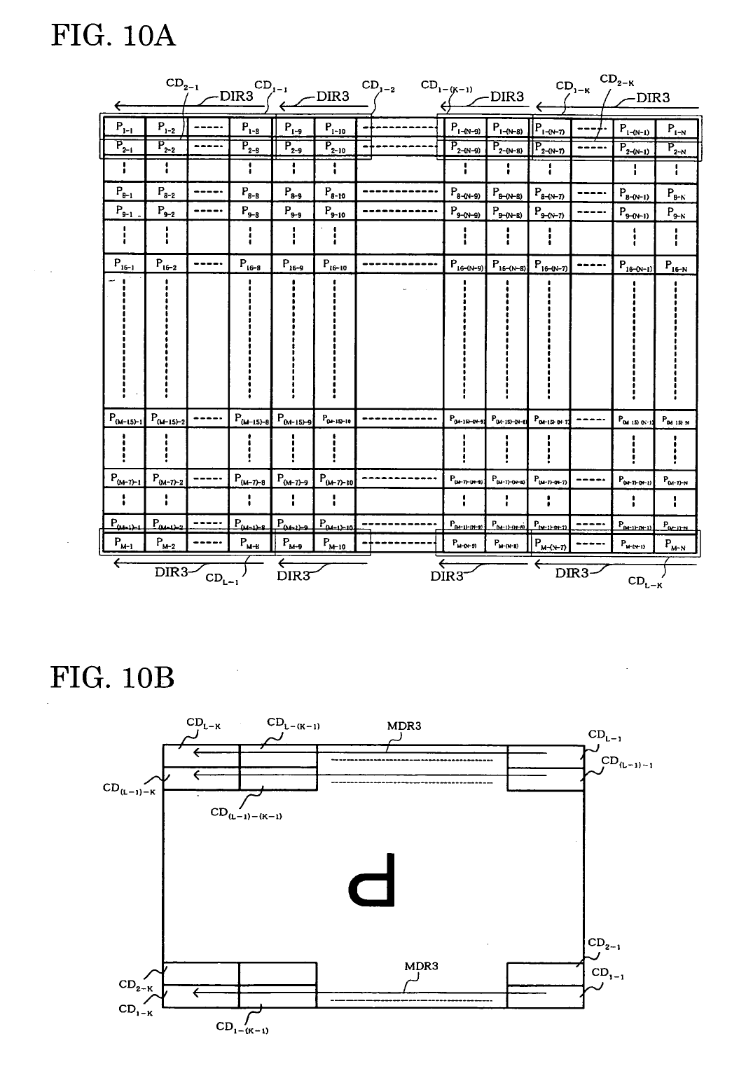

FIGS. 10A and 10B are views illustrative of the operation of the rotation processing section 150 when the rotation angle is 180°.

FIG. 10A is a view showing the input image IMG0 shown in FIG. 7 in which the image data is arranged in pixel units. In FIG. 10A, N pixels are arranged in the horizontal scan direction of the input image IMG0, and M pixel are arranged in the vertical scan direction of the input image IMG0. Pixels P₁₋₁, P₁₋₂, . . . , P_{1-N} are arranged in the horizontal scan direction of the input image IMG0, and pixels P₁₋₁, P₂₋₁, . . . , P_{M-1} are arranged on the left end in the vertical scan direction of the input image IMG0, for example.

FIG. 10B schematically shows a state in which the image data after the rotation process (rotation angle: 180°) is stored in the memory 120.

In this example, the compression section 100 performs the compression process in eight pixel units. In FIG. 10A, the pixels P₁₋₈ to P₁₋₁ are compressed as shown in FIG. 4C in a direction DIR3 to generate encoded data CD₁₋₁. Likewise, the pixels P₁₋₁₆ to P₁₋₉, . . . , the pixels P_{1-(N-7)} to P_{1-N}, the pixels P₂₋₈ to P₂₋₁, the pixels P₂₋₁₆ to P₂₋₉, . . . , the pixels P_{2-(N-7)} to P_{2-N}, . . . , the pixels P_{M-8} to P_{M-1}, . . . , and the pixels P_{M-(N-7)} to P_{M-N} are compressed in the direction DIR3 to generate encoded data CD₁₋₂, . . . , CD_{1-K}, CD₂₋₁, CD₂₋₂, . . . , CD_{2-K}, . . . , CD_{L-1}, . . . , and CD_{L-K}.

The encoded data thus generated is stored in the memory 120 in an order MDR3 shown in FIG. 10B. Specifically, the encoded data CD₁₋₁ to CD_{1-K} is stored in the memory 120 in the order MDR3, and the encoded data CD₂₋₁ to CD_{2-K} is then stored in the memory 120 in the order MDR3. The write address generation circuit 310 generates the write address of the line buffer section 350 so that the compression process is performed in the order shown in FIG. 10B.

As a result, it suffices that the first and second decompression sections 130 and 132 read the encoded data from the memory 120 in a raster scan direction. Specifically, the read address generation circuit 320 generates the read address of the line buffer section 350 so that encoded data CD_{L-K}, CD_{L-(K-1)}, . . . , CD_{L-1}, CD_{(L-1)-K}, CD_{(L-1)-(K-1)}, . . . , CD_{1-K}, . . . , and CD₁₋₁ is read in that order, and the decompression process is sequentially performed on the encoded data, whereby the image data of the image IMG2 when the rotation angle is 180° can be output.

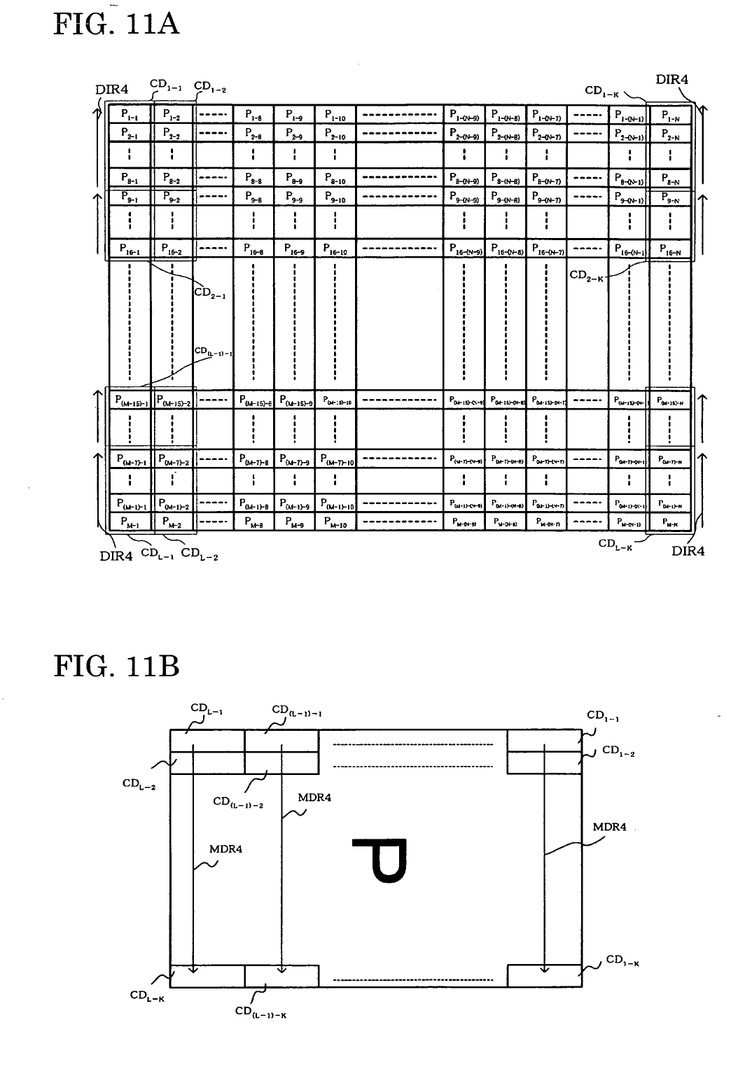

FIGS. 11A and 11B are views illustrative of the operation of the rotation processing section 150 when the rotation angle is 270°.

FIG. 11A is a view showing the input image IMG0 shown in FIG. 7 in which the image data is arranged in pixel units. In FIG. 11A, N pixels are arranged in the horizontal scan direction of the input image IMG0, and M pixel are arranged in the vertical scan direction of the input image IMG0. Pixels P₁₋₁, P₁₋₂, . . . , P_{1-N} are arranged in the horizontal scan direction of the input image IMG0, and pixels P₁₋₁, P₂₋₁, . . . , P_{M-1} are arranged on the left end in the vertical scan direction of the input image IMG0, for example.

FIG. 11B schematically shows a state in which the image data after the rotation process (rotation angle: 270°) is stored in the memory 120.

In this example, the compression section 100 performs the compression process in eight pixel units. In FIG. 11A, the pixels P₁₋₁ to P₈₋₁ are compressed as shown in FIG. 4C in a direction DIR4 to generate encoded data CD₁₋₁, for example. Likewise, the pixels P₁₋₂ to P₈₋₂, . . . , the pixels P_{1-N} to P_{8-N}, the pixels P₉₋₁ to P₁₆₋₁, . . . , the pixels P₉₋₂ to P₁₆₋₂, . . . , the pixels P_{9-N} to P_{16-N}, . . . , the pixels P_{(M-7)-1} to P_{M-1}, . . . , and the pixels P_{(M-7)-N} to P_{M-N} are compressed in the direction DIR4 to generate encoded data CD₁₋₂, . . . , CD_{1-K}, CD₂₋₁, . . . , CD_{2-K}, . . . , CD_{L-1}, . . . , and CD_{L-K}.

The encoded data thus generated is stored in the memory 120 in an order MDR4 shown in FIG. 11B. Specifically, the encoded data CD₁₋₁ to CD_{1-K} is stored in the memory 120 in the order MDR2, the encoded data CD₂₋₁ to CD_{2-K} is then stored in the memory 120 in the order MDR4, and the encoded data CD_{L-1} to CD_{L-K} is then stored in the memory 120 in the order MDR4. Specifically, the write address generation circuit 310 generates the write address of the line buffer section 350 so that the compression process is performed in the order shown in FIG. 11B.

As a result, it suffices that the first and second decompression sections 130 and 132 read the encoded data from the memory 120 in a raster scan direction. Specifically, the read address generation circuit 320 generates the read address of the line buffer section 350 so that encoded data CD_{L-1}, CD_{(L-1)-1}, . . . , CD₁₋₁, CD_{L-2}, CD_{(L-1)-2}, . . . , CD₁₋₂, . . . , CD_{L-K}, . . . , and CD_{1-K} is read in that order, and the decompression process is sequentially performed on the encoded data, whereby the image data of the image IMG3 when the rotation angle is 270° can be output.

According to this embodiment, the image data corresponding to one screen need not be stored in the work area necessary for the rotation process. When performing the compression process in units of 8-pixel blocks, it suffices to provide line buffers which store at least the image data corresponding to eight scan lines. When performing the compression process in units of 4-pixel blocks, it suffices to provide line buffers which store at least the image data corresponding to four scan lines.

Note that rotation processing section 150 according to this embodiment is not limited to the processes shown in FIGS. 8A and 8B, FIGS. 9A and 9B, FIGS. 10A and 10B, and FIGS. 11A and 11B.

2.3 Compression Section

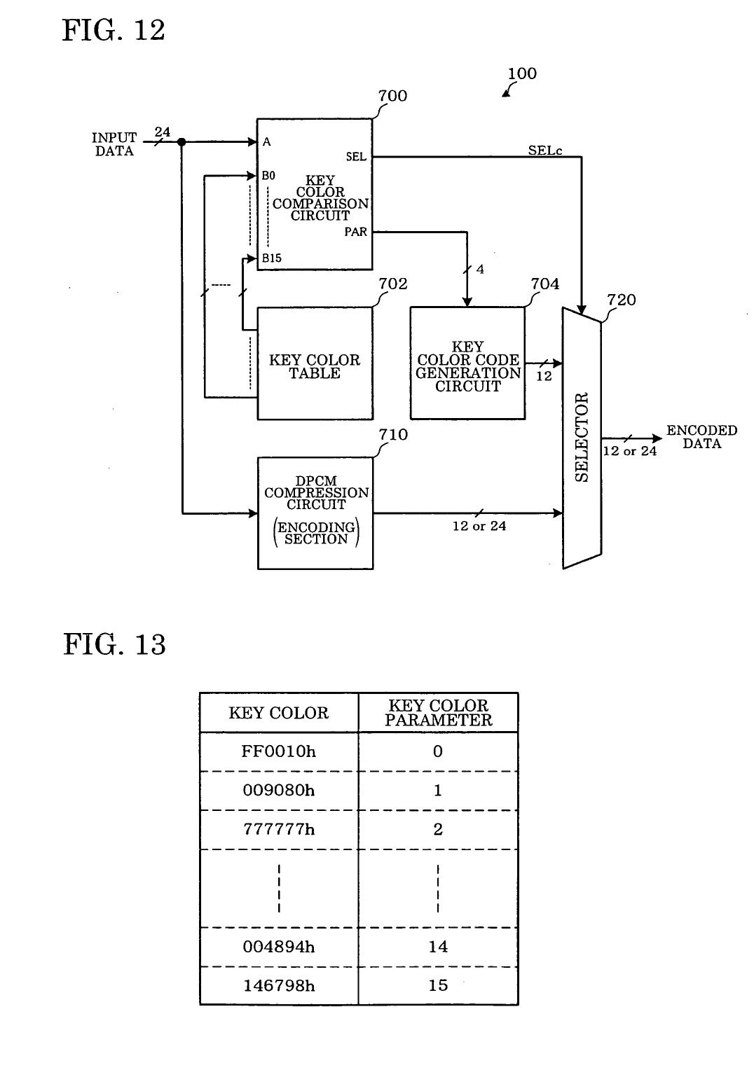

FIG. 12 is a block diagram showing a configuration example of the compression section 100 shown in FIG. 2.

FIG. 12 shows an example in which the image data of the image input from the baseband engine 10 is in an RGB888 format.

The compression section 100 includes a key color comparison circuit (key color comparison section) 700, a key color table 702, a key color code generation circuit 704, a DPCM compression circuit (encoding section) 710, and a selector 712. In FIG. 12, the compression section 100 includes the key color table 702. Note that the control register section 190 shown in FIG. 5 may include the key color table 702.

The image data subjected to the rotation process by the rotation processing section 150 and 16 types of key color data stored in the key color table 702 are input to the key color comparison circuit 700. The key color comparison circuit 700 determines (compares) whether or not the image data subjected to the rotation process coincides with one of the 16 types of key color data stored in the key color table 702 in pixel units. When the key color comparison circuit 700 has determined that the image data coincides with one of the 16 types of key color data, the key color comparison circuit 700 activates the select control signal SELc. In this case, the key color comparison circuit 700 outputs a 4-bit key color parameter which indicates the key color that coincides with the image data to the key color code generation circuit 704.

The key color code generation circuit 704 generates a key color code using the key color parameter output from the key color comparison circuit 700.

FIG. 13 is a view illustrative of the key color table 702 shown in FIG. 12.

16 key colors are set in the key color table 702. Each key color is designated by 24-bit key color data. A key color parameter which can be represented by four bits is assigned to each key color. The key color comparison circuit 700 outputs the key color parameter assigned to the key color data which coincides with the image data.

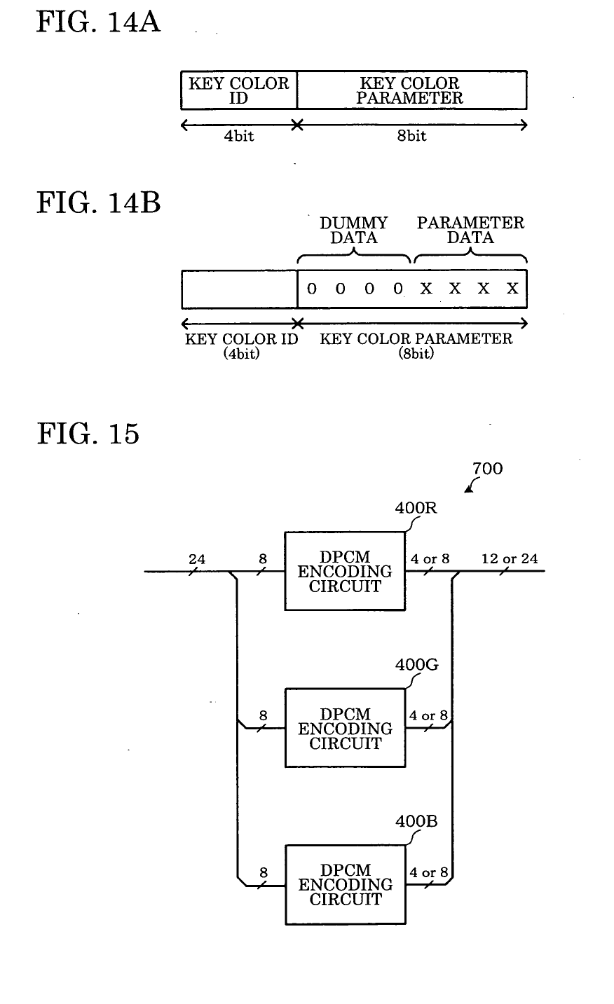

FIGS. 14A and 14B are views illustrative of the operation of the key color code generation circuit 704 shown in FIG. 12.

In this embodiment, a key color ID which indicates a key color is determined in advance. The decoding side can easily determine that the data read from the memory 120 is the key color by setting the key color ID at the head of the key color code. In this embodiment, a key color code is generated in which the 4-bit key color ID (fixed value) is set at the head and the 8-bit key color parameter is set subsequent to the key color ID.

As shown in FIGS. 4A to 4C, the key color code generation circuit 704 generates the key color code so that the bit length of the key color code is equal to or less than the number of bits which maintains the predetermined compression rate in order to ensure that the compression section 100 encodes the image data at a compression rate equal to or higher than the predetermined compression rate. As shown in FIG. 14B, the key color code generation circuit 704 adjusts the key color code so that the bit length of the key color code is equal to the number of bits (12 bits) which maintains the predetermined compression rate by inserting 4-bit dummy data (“0000” in FIG. 14B), for example. This enables the compression section 100 to encode the image data at a compression rate equal to or higher than the predetermined compression rate even if the key color code is output instead of the encoded data. Moreover, the decompression side can simply determine the key color code if the bit length of the key color code is fixed.

Again referring to FIG. 12, The DPCM compression circuit 710 compresses the image data subjected to the rotation process using the DPCM encoding algorithm (i.e., lossy compression algorithm) to generate encoded data.

The selector 720 outputs the key color code generated by the key color code generation circuit 704 or the encoded data output from the DPCM compression circuit 710 based on the select control signal SELc output from the key color comparison circuit 700. Specifically, the selector 720 outputs the key color code as the encoded data when the select control signal SELc is active, and outputs the encoded data output from the DPCM compression circuit 710 when the select control signal SELc is inactive.

FIG. 15 is a block diagram showing a configuration example of the DPCM compression circuit 710 shown in FIG. 12.

The DPCM compression circuit 710 includes DPCM encoding circuits 400R, 400G, and 400B. The DPCM encoding circuits 400R, 400G, and 400B have an identical configuration.

When the image data is in an RGB888 format, the image data input through the host I/F 140 and the rotation processing section 150 is 24 bits per pixel. The 8-bit R-component image data is input to the DPCM encoding circuit 400R, the 8-bit G-component image data is input to the DPCM encoding circuit 400G, and the 8-bit B-component image data is input to the DPCM encoding circuit 400B.

Each DPCM encoding circuit outputs the 8-bit image data as 4-bit encoded data for the compression target pixel. Specifically, the compression section 100 encodes the image data in color component units. Each DPCM encoding circuit directly outputs the 8-bit image data for pixels other than the compression target pixel.

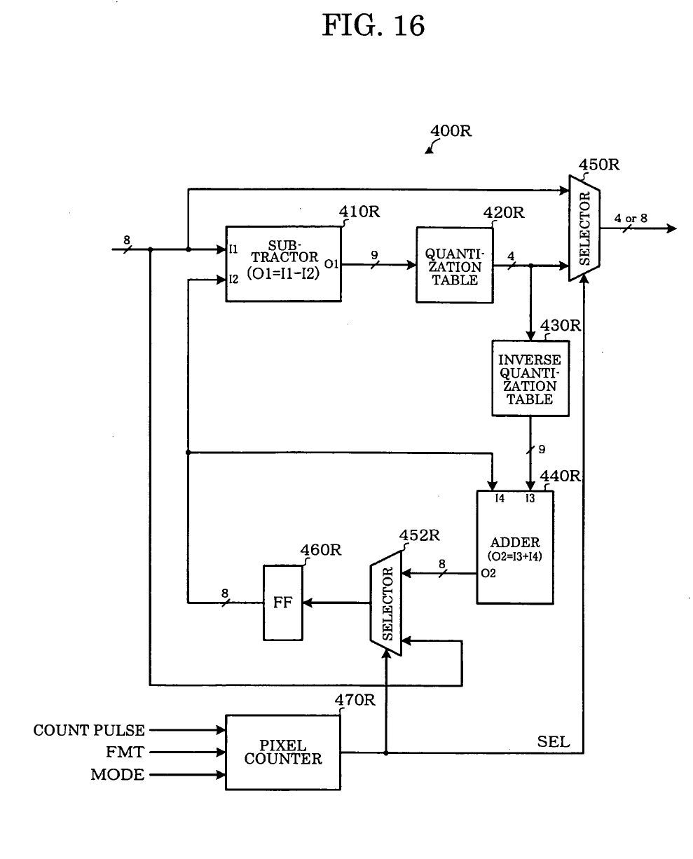

FIG. 16 is a block diagram showing a configuration example of the DPCM encoding circuit 400R shown in FIG. 15.

The DPCM encoding circuits 400G and 400B have the same configuration as that of the DPCM encoding circuit 400R shown in FIG. 16.

The DPCM encoding circuit 400R includes a subtractor 410R, a quantization table 420R, an inverse quantization table 430R, an adder 440R, selectors 450R and 452R, a flip-flop 460R, and a pixel counter 470R.

The subtractor 410R calculates the difference between the input 8-bit image data and 8-bit image data held by the flip-flop 460R, and outputs 9-bit difference data including a carry bit (borrow bit). The difference data is supplied to the quantization table 420R.

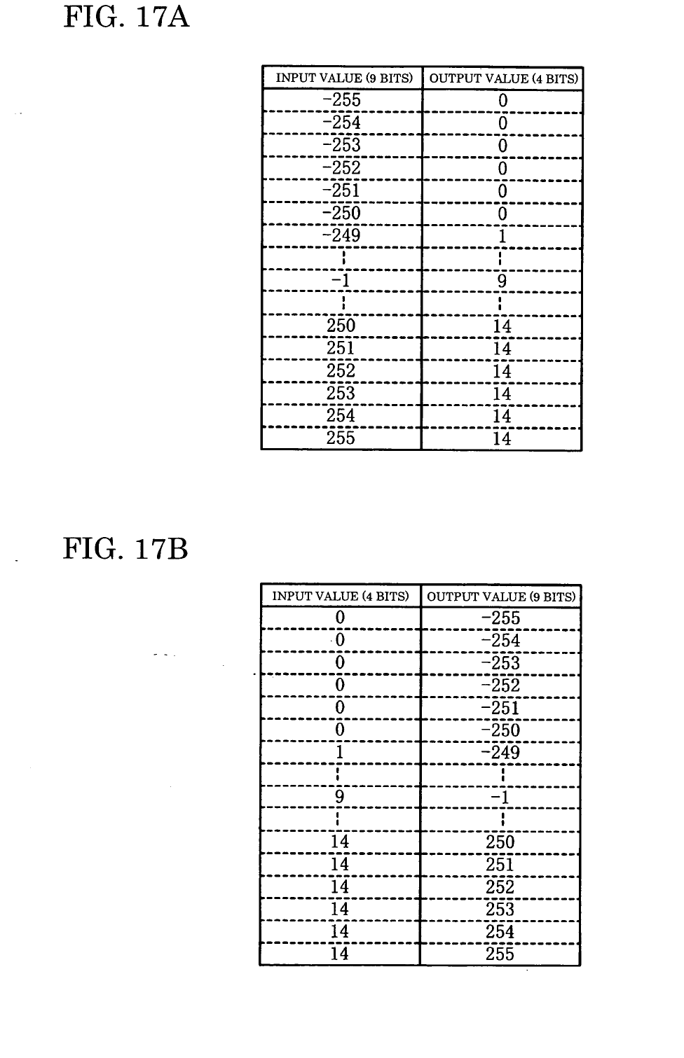

FIG. 17A schematically shows the configuration of the quantization table 420R shown in FIG. 16.

A 4-bit output value corresponding to the 9-bit input value is registered in advance in the quantization table 420R. The output value is a value obtained by quantizing the input value. The output value indicates the quantized value in four bits. The quantization table 420R receives the 9-bit difference data from the subtractor 410R as the input value, and outputs the quantized data as the 4-bit output value. The quantized data is supplied to the inverse quantization table 430R.

FIG. 17B schematically shows the configuration of the inverse quantization table 430R shown in FIG. 16.

The inverse quantization table 430R is a table corresponding to the quantization table 420R. A 9-bit output value corresponding to the 4-bit input value is registered in advance in the inverse quantization table 430R. The output value is a value obtained by inverse quantization of the input value. The output value indicates the quantized value in nine bits. Specifically, the values of the quantization table 420R and the inverse quantization table 430R are registered so that the output value of the inverse quantization table 430R corresponds to the input value of the quantization table 420R.

The inverse quantization table 430R receives the quantized data from the quantization table 420R as the input value, and outputs the inverse-quantized data as the 9-bit output value.

Again referring to FIG. 16, the quantized data from the quantization table 420R is also input to the selector 450R. The 8-bit image data from the rotation processing section 150 and the 4-bit quantized data are input to the selector 450R. The selector 450R outputs either the 8-bit image data from the rotation processing section 150 or the 4-bit quantized data based on a select control signal SBL generated by the pixel counter 470R. The 4-bit or 8-bit output data from the selector 450R is the encoded data shown in FIG. 4A, and is stored in the memory 120.

The inverse-quantized data is input to the adder 440R. The 9-bit inverse-quantized data and the 8-bit image data held by the flip-flop 460R are input to the adder 440R. The adder 440R adds the inverse-quantized data to the image data held by the flip-flop 460R, and supplies 8-bit addition data to the selector 452R.

The 8-bit addition data from the adder 440R and the 8-bit image data input through the host I/F 140 are input to the selector 452R. The selector 452R outputs either the 8-bit addition data from the adder 440R or the 8-bit image data input through the host I/F 140 based on the select control signal SEL generated by the pixel counter 470R. The data selected by the selector 452R is held by the flip-flop 460R. The flip-flop 460R latches the data selected by the selector 452R using a count pulse which is incremented in units of the color components of the image data input through the host I/F 140, for example.

The count pulse and the control signals FMT and MODE are input to the pixel counter 470R. When the line mode is designated by the control signal MODE, the pixel counter 470R generates the select control signal SEL so that DPCM encoding is performed in scan line units. In the line mode, only the first pixel of one scan line is output directly, and the difference from the preceding pixel is quantized for the subsequent pixels. When the partial mode is designated by the control signal MODE, the pixel counter 470R generates the select control signal SEL at the timing specified by the count pulse corresponding to the image format designated by the control signal FMT.

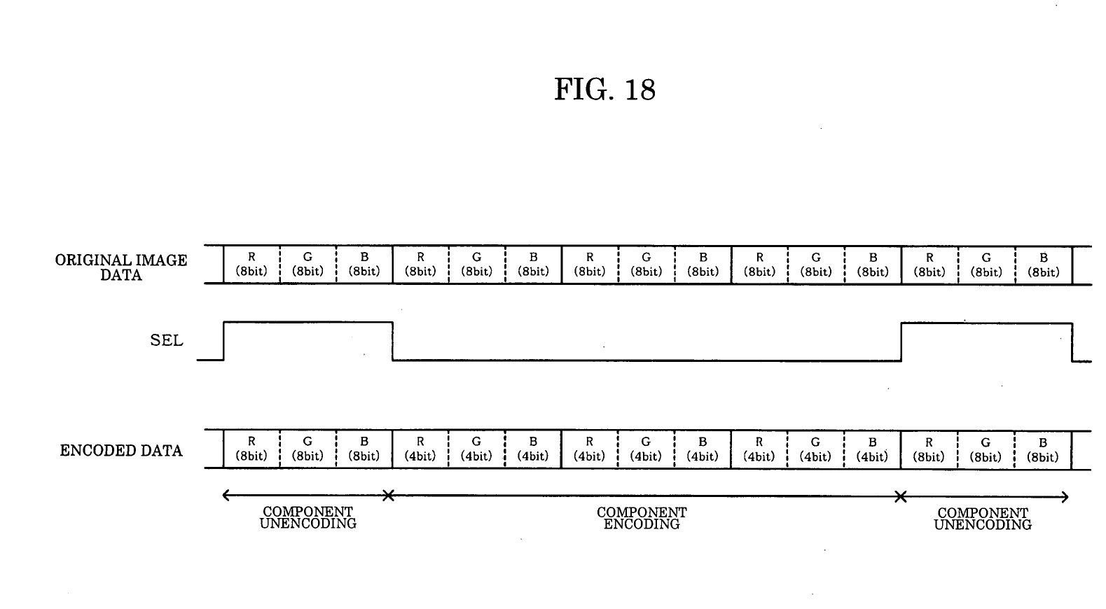

FIG. 18 is a timing diagram showing an operation example of the pixel counter 470R shown in FIG. 16.

FIG. 18 shows an operation example of the pixel counter 470R when the partial mode is designated by the control signal MODE.

When an RGB888 format is designated by the control signal FMT, the pixel counter 470R generates the select control signal SEL so that the first pixel is output without being compressed. A component unencoding period can be specified using the select control signal SEL. Therefore, the selectors 450R and 452R select and output the 8-bit image data input from the outside. As a result, the compression section 100 can output the 8-bit input image data as the encoded data.

The pixel counter 470R generates the select control signal SEL so that the second to fourth pixels subsequent to the first pixel are encoded. A component encoding period can be specified using the select control signal SEL. Therefore, the selector 450R outputs the quantized data, and the selector 452R outputs the addition data. Accordingly, the data obtained by quantizing the difference from the adjacent pixel is output as the encoded data (component encoding period).

When the line mode is designated by the control signal MODE, the remaining pixels of the scan line are encoded in the same manner as the second to fourth pixels in the partial mode.

Although FIGS. 15 to 18 illustrate an example of the RGB888 format, the image data in another image format can be similarly encoded by causing the pixel counter 470R to change the timing of the select control signal SEL corresponding to the image format.

The configuration of the compression section 100 is not limited to the configuration described with reference to FIGS. 12 to 18.

2.4 Decompression Section (First Decompression Section and Second Decompression Section)

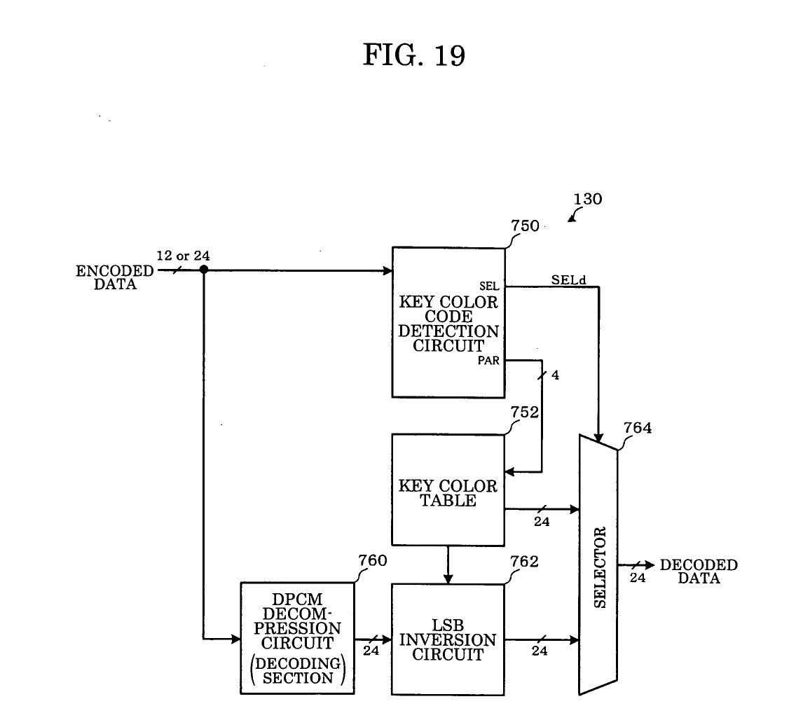

FIG. 19 is a block diagram showing a configuration example of the first decompression section 130 shown in FIG. 2.

Note that the second decompression section 132 has the same configuration as that of the first decompression section 130 described with reference to FIG. 19. FIG. 19 shows an example in which the image data is in an RGB888 format.

The first decompression section 130 includes a key color code detection circuit (key color code detection section) 750, a key color table 752, a DPCM decompression circuit (decoding section) 760, a least significant bit (LSB) inversion circuit 762, and a selector 764. In FIG. 19, the first decompression section 130 includes the key color table 752. Note that the control register section 190 shown in FIG. 5 may include the key color table 752.

The encoded data from the memory 120 is input to the key color code detection circuit 750. A key color ID which indicates a key color is set in advance in the key color code detection circuit 750. The key color code detection circuit 750 detects whether or not the encoded data from the memory 120 is the key color code based on the key color ID. When the key color code detection circuit 750 has determined that the encoded data from the memory 120 is the key color code, the key color code detection circuit 750 activates a select control signal SELe, and outputs the 4-bit key color parameter set in the key color code.

The image data which indicates the key color associated with the key color parameter is registered in the key color table 752, as shown in FIG. 13. The key color table 752 receives the 4-bit key color parameter from the key color code detection circuit 750, and outputs the 24-bit image data designated as the key color. The key color table 752 outputs 16 types of key color data to the LSB inversion circuit 762.

The DPCM compression circuit 760 decompresses the encoded data from the memory 120 using a DPCM decoding algorithm corresponding to the DPCM encoding algorithm (i.e., lossy compression algorithm) to generate decoded data.

The LSB inversion circuit 762 detects whether or not the color indicated by the decoded data (first decoded data) obtained by the decompression process of the DPCM decompression circuit 760 coincides with one of the 16 key colors registered in the key color table 752. When the LSB inversion circuit 762 has detected that the color indicated by the decoded data (first decoded data) coincides with one of the 16 key colors, the LSB inversion circuit 762 outputs decoded data (second decoded data) differing from the decoded data (first decoded data) instead of the decoded data (first decoded data). As decoded data (second decoded data) differing from the decoded data (first decoded data), the LSB inversion circuit 762 may generate data by reversing the least significant bit of at least one of the R component data, the G component data, and the B component data of the decoded data, for example.

The selector 764 outputs the image data from the key color table 752 or the decoded data from the LSB inversion circuit 762 based on the select control signal SELe from the key color code detection circuit 750. Specifically, the selector 764 outputs the image data from the key color table 752 when the select control signal SELe is active, and outputs the decoded data from the LSB inversion circuit 762 when the select control signal SELe is inactive.

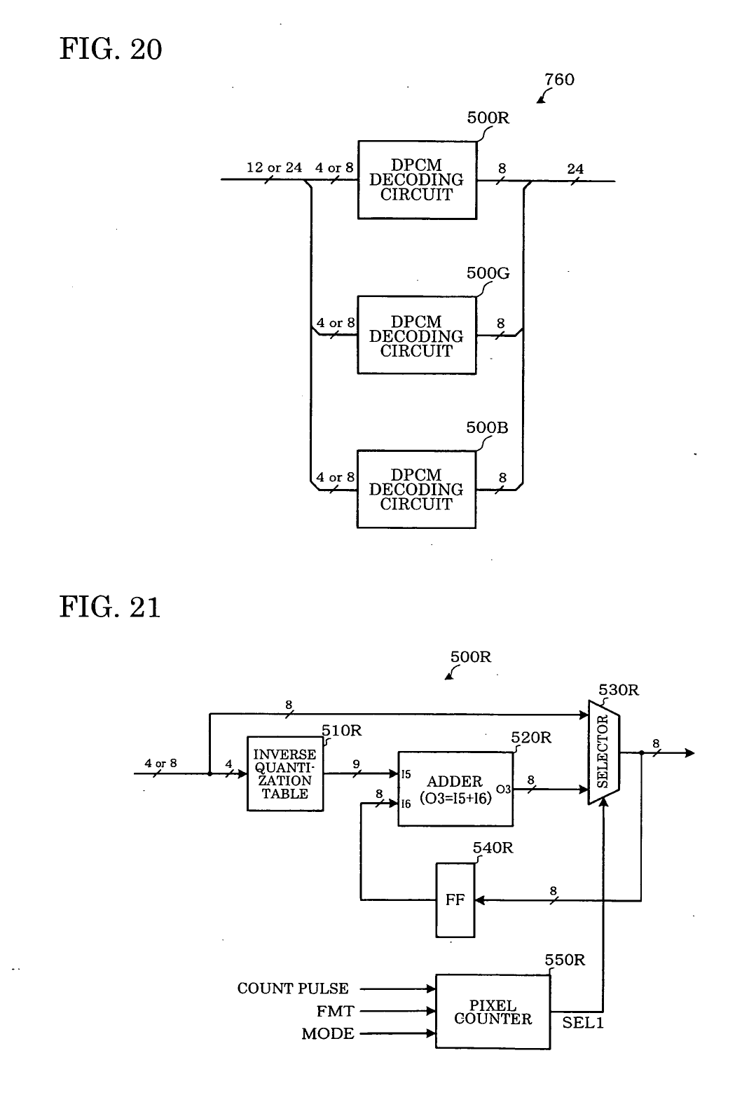

FIG. 20 is a block diagram showing a configuration example of the DPCM decompression circuit 760 shown in FIG. 19.

The DPCM decompression circuit 760 includes DPCM decoding circuits 500R, 500G, and 500B. The DPCM decoding circuits 500R, 500G, and 500B have an identical configuration.

The 8-bit image data of the R component of the first pixel is input to the DPCM decoding circuit 500R, and the 4-bit encoded data of the R component of the second to fourth pixels is then sequentially input to the DPCM decoding circuit 500R. The 8-bit image data of the G component of the first pixel is input to the DPCM decoding circuit 500G, and the 4-bit encoded data of the G component of the second to fourth pixels is then sequentially input to the DPCM decoding circuit 500G. The 8-bit image data of the B component of the first pixel is input to the DPCM decoding circuit 500B, and the 4-bit encoded data of the B component of the second to fourth pixels is then sequentially input to the DPCM decoding circuit 500B.

Each DPCM decoding circuit outputs the 4-bit encoded data as the 8-bit image data for the compression target pixel. The first decompression section 130 decodes the image data in color component units. Each DPCM decoding circuit directly outputs the 8-bit encoded data for pixels other than the compression target pixel.

FIG. 21 is a block diagram showing a configuration example of the DPCM decoding circuit 500R shown in FIG. 20.

Note that the DPCM decoding circuits 500G and 500B have the same configuration as that of the DPCM decoding circuit 500R shown in FIG. 21.

The DPCM decoding circuit 500R includes an inverse quantization table 510R, an adder 520R, a selector 530R, a flip-flop 540R, and a pixel counter 550R.

The inverse quantization table 510R is similar to the inverse quantization table 430R shown in FIG. 16. The inverse quantization table 510R may have the function shown in FIG. 17B. Specifically, the inverse quantization table 510R converts the 4-bit encoded data into 9-bit inverse-quantized data.

The inverse-quantized data from the inverse quantization table 510R and 8-bit image data held by the flip-flop 540R are input to the adder 540R. The adder 540R adds the inverse-quantized data to the image data held by the flip-flop 540R, and outputs 8-bit addition data. The addition data is input to the selector 530R.

The 8-bit image data which is not compressed and the addition data are input to the selector 530R. The selector 530R outputs either the 8-bit image data or the addition data based on a select control signal SEL1 generated by the pixel counter 550R. The data selected by the selector 530R is held by the flip-flop 540R.

The flip-flop 540R latches the data selected by the selector 530R using a count pulse which is incremented in units of the color components of the image data read from the memory 120.

The count pulse and the control signals FMT and MODE are input to the pixel counter 550R. When the line mode is designated by the control signal MODE, the pixel counter 470R generates the select control signal SEL1 so that DPCM decoding is performed in scan line units. In the line mode, only the first pixel of one scan line is output directly, and the subsequent pixels are subjected to DPCM decoding. When the partial mode is designated by the control signal MODE, the pixel counter 550R generates the select control signal SEL1 at the timing specified by the count pulse corresponding to the image format specified by the control signal FMT.

When the line mode is designated and an RGB888 format is designated by the control signal FMT, the pixel counter 550R generates the select control signal SEL1 so that the first pixel is output without being decompressed. Therefore, the selector 530R selects and outputs the image data read from the memory 120. The pixel counter 550R generates the select control signal SEL1 so that the remaining pixels of the scan line subsequent to the first pixel are decoded. Therefore, the selector 530R outputs the addition data. As a result, the first decompression section 130 can output the 8-bit image data subjected to DPCM decoding.

When the partial mode is designated and an RGB888 format is designated by the control signal FMT, the pixel counter 550R generates the select control signal SEL1 so that the first pixel is output without being decompressed. Therefore, the selector 530R selects and outputs the image data read from the memory 120. The pixel counter 550R generates the select control signal SEL1 so that the second to fourth pixels subsequent to the first pixel are decoded. Therefore, the selector 530R outputs the addition data.

Although FIGS. 19 to 21 illustrate an example of the RGB888 format, image data in another image format can be similarly decoded by causing the pixel counter 550R to change the timing of the select control signal SEL1 corresponding to the image format.

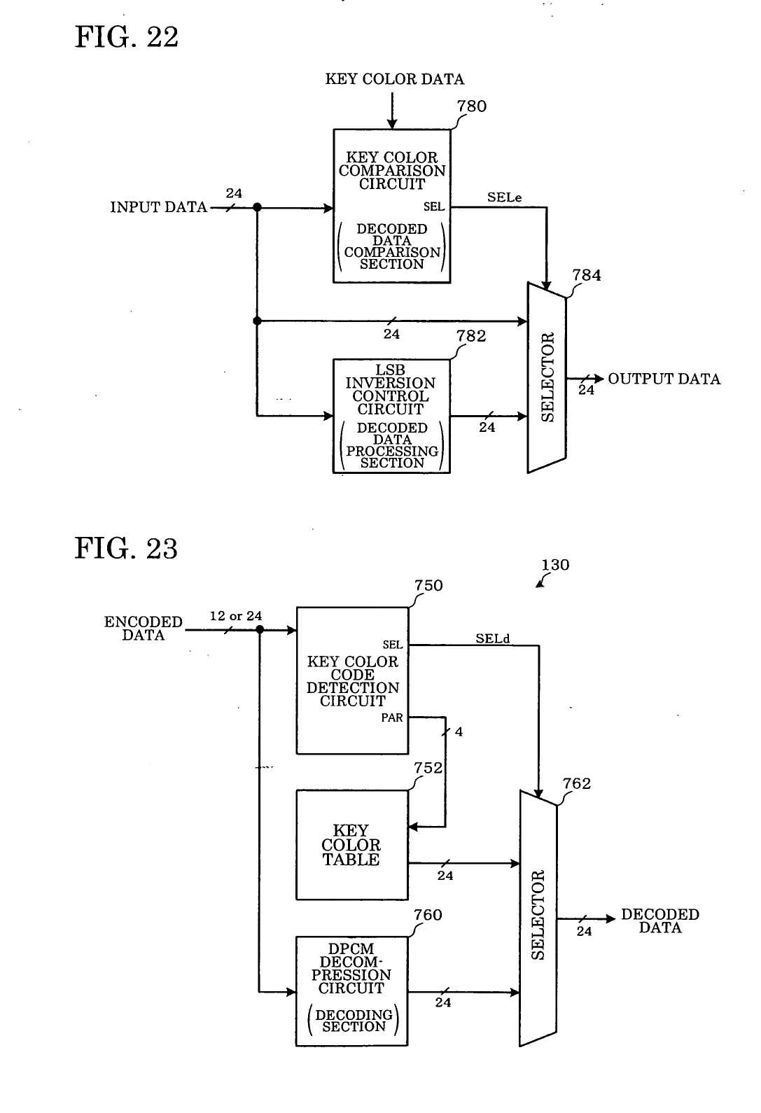

FIG. 22 is a block diagram showing a configuration example of the LSB inversion circuit 762 shown in FIG. 19.

The LSB inversion circuit 762 includes a key color comparison circuit 780 which functions as a decoded data comparison section, an LSB inversion control circuit 782 which functions as a decoded data processing section, and a selector 784.

The 24-bit decoded data decoded by the DPCM decompression circuit 760 and the 16 types of key color data output from the key color table 752 are input to the key color comparison circuit 780. The key color comparison circuit 780 detects whether or not the decoded data coincides with one of the 16 types of key color data. When the key color comparison circuit 780 has detected that the decoded data coincides with one of the 16 types of key color data, the key color comparison circuit 780 activates the select control signal SELe.

The LSB inversion control circuit 782 generates decoded data differing from the 24-bit decoded data decoded by the DPCM decompression circuit 760 based on the 24-bit decoded data decoded by the DPCM decompression circuit 760. Specifically, when the decoded data includes the image data of one or more color components, the LSB inversion control circuit 782 generates another piece of decoded data by changing the image data of at least one color component. More specifically, the LSB inversion control circuit 782 generates decoded data differing from the input decoded data by reversing the least significant bit of the image data of at least one color component of the decoded data.

The selector 784 selects and outputs the decoded data decompressed by the DPCM decompression circuit 760 or the decoded data output from the LSB inversion control circuit 782 based on the select control signal SELe. Specifically, the selector 784 outputs the decoded data output from the LSB inversion control circuit 782 as the decoded data when the select control signal SELe is active, and outputs the decoded data decompressed by the DPCM decompression circuit 760 when the select control signal SELe is inactive.

The data selected and output from the selector 784 is output from the first decompression section 130, whereby the first decompression section 130 can output the 8-bit image data subjected to DPCM decoding.

The configuration of the first decompression section 130 is not limited to FIGS. 19 and 22. Various modifications may be made.

FIG. 23 shows a second configuration example of the first extension processing section 130. In the second configuration example shown in FIG. 23, the LSB inversion circuit 762 shown in FIG. 19 is omitted. Although FIG. 23 shows the second configuration example of the first decompression section 130, the same configuration may be employed for the second decompression section 132. FIG. 23 shows an example in which the image data is in an RGB888 format.

The first decompression section 130 shown in FIG. 23 includes a key color code detection circuit (key color code detection section) 750, a key color table 752, a DPCM decompression circuit (decoding section) 760, and a selector 762. In FIG. 23, the first decompression section 130 includes the key color table 752. Note that the control register section 190 shown in FIG. 5 may include the key color table 752.

The encoded data from the memory 120 is input to the key color code detection circuit 750. A key color ID which indicates a key color is set in advance in the key color code detection circuit 750. The key color code detection circuit 750 detects whether or not the encoded data from the memory 120 is the key color code based on the key color ID. When the key color code detection circuit 750 has determined that the encoded data from the memory 120 is the key color code, the key color code detection circuit 750 activates a select control signal SELd, and outputs the 4-bit key color parameter set in the key color code.

The image data which indicates the key color associated with the key color parameter is registered in the key color table 752, as shown in FIG. 13. The key color table 752 receives the 4-bit key color parameter from the key color code detection circuit 750, and outputs the 24-bit image data designated as the key color.

The DPCM compression circuit 760 decompresses the encoded data from the memory 120 using a DPCM decoding algorithm corresponding to the DPCM encoding algorithm (i.e., lossy compression algorithm) to generate decoded data.

The selector 762 outputs the image data from the key color table 752 or the decoded data from the DPCM decompression circuit 760 based on the select control signal SELd from the key color code detection circuit 750. Specifically, the selector 762 outputs the image data from the key color table 752 as the decoded data when the select control signal SELd is active, and outputs the decoded data from the DPCM decompression circuit 760 when the select control signal SELd is inactive.

2.5 Overlay Processing Section

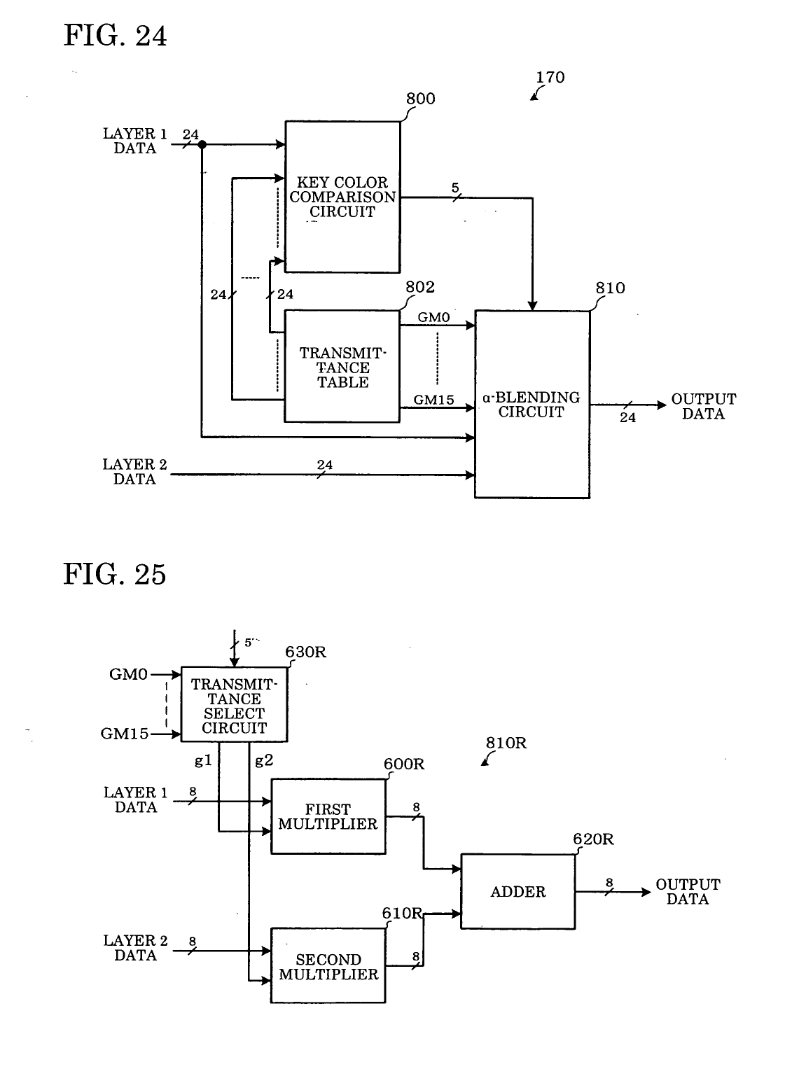

FIG. 24 is a block diagram showing a configuration example of the overlay processing section 170 shown in FIG. 2.

The overlay processing section 170 includes a key color comparison circuit 800, a transmittance table 802, and an α-blending circuit 810.

The 24-bit decoded data is input to the key color comparison circuit 800 as layer 1 data through the first format conversion section 160, and the 24-bit decoded data is input to the key color comparison circuit 800 as layer 2 data through the second format conversion section 162.

A transmittance corresponding to the key color is registered in the transmittance table 802 through the overlay process setting register 220. In FIG. 24, the overlay processing section 170 includes the transmittance table 802. Note that the control register section 190 may include the transmittance table 802. The transmittance table 802 outputs the 16 types of 24-bit key color data to the key color comparison circuit 800, and outputs 16 transmittances GM0 to GM15 corresponding to the key colors to the α-blending circuit 810.

The key color comparison circuit 800 determines (compares) whether or not the layer 1 data coincides with one of the 16 types of key color data output from the transmittance table 802 in pixel units, for example. When the image data coincides with one of the 16 types of key color data, the key color comparison circuit 800 outputs a 1-bit coincidence detection bit and a 4-bit key color parameter which indicates the key color that coincides with the image data.

The layer 1 data, the layer 2 data, the transmittance from the transmittance table 802, the coincidence detection bit, and the key color parameter are input to the α-blending circuit 810. The α-blending circuit 810 performs the overlay process on the layer 1 data and the layer 2 data using the layer 1 data, the layer 2 data, the transmittance from the transmittance table 802, the coincidence detection bit, and the key color parameter, and outputs output data.

The α-blending circuit 810 includes an overlay processing circuit which performs the overlay process on the image data from the first and second format conversion sections 160 and 162 in units of RGB color components.

FIG. 25 is a block diagram showing a configuration example of the R-component overlay processing circuit of the a-blending circuit 810 shown in FIG. 24. Note that G-component and B-component overlay processing circuits have the same configuration as that of the R-component overlay processing circuit shown in FIG. 25.

An R-component overlay processing circuit 170R of the α-blending circuit 810 includes first and second multipliers 600R and 610R, an adder 620R, and a transmittance select circuit 630R.

The transmittance select circuit 630R selects two transmittances from the transmittances GM0 to GM15 output from the transmittance table 802 based on the 1-bit coincidence detection bit and the 4-bit key color parameter output from the key color comparison circuit 800, and outputs the selected transmittances as transmittances g1 and g2.

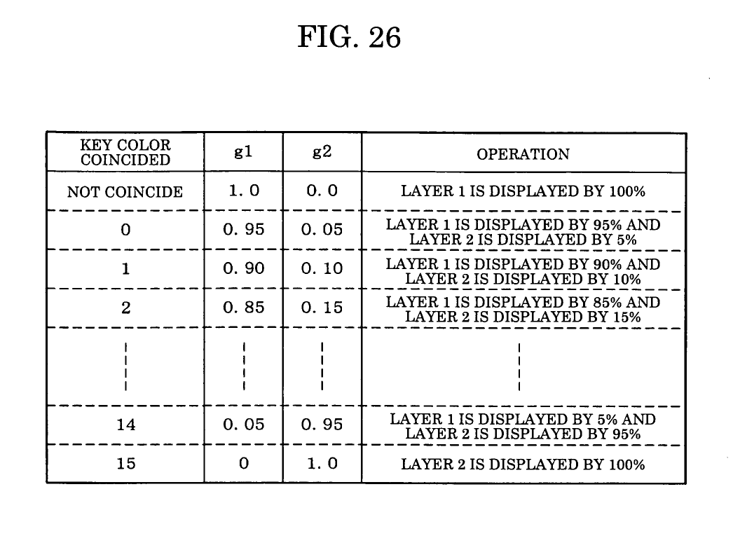

FIG. 26 is a view illustrative of the operation of the transmittance select circuit 630R shown in FIG. 25.

When the coincidence detection bit indicates that the image data does not coincide with the key color data, the transmittance select circuit 630R outputs “1” as the transmittance g1 and outputs “0” as the transmittance g2.

When the coincidence detection bit indicates that the image data coincides with the key color data and the key color parameter indicates that the key color 0 coincides with the image data, the transmittance select circuit 630R outputs “0.95” as the transmittance g1 and outputs “0.05” as the transmittance g2. Likewise, when the coincidence detection bit indicates that the image data coincides with the key color data and the key color parameter indicates that the key color 14 coincides with the image data, the transmittance select circuit 630R outputs “0.05” as the transmittance g1 and outputs “0.95” as the transmittance g2.

Again referring to FIG. 25, the control signal GM1 and the image data subjected to format conversion by the first format conversion section 160 are input to the first multiplier 600R. For example, the first multiplier 600R multiplies the image data by a transmittance designated by the control signal GM1 in color component units, and outputs the multiplied data to the adder 620R.

The control signal GM2 and the image data subjected to format conversion by the second format conversion section 160 are input to the second multiplier 610R. For example, the second multiplier 610R multiplies the image data by a transmittance designated by the control signal GM2 in color component units, and outputs the multiplied data to the adder 620R.

The adder 620R adds the multiplied data from the first multiplier 600R and the multiplied data from the second multiplier 610R in color component units, and outputs the resulting data as overlaid data.

When the multiplied data from the first multiplier 600R is referred to as MD1 and the multiplied data from the second multiplier 610R is referred to as MD2, output data OD from the adder 620R is expressed by the following equation,

OD(R)=MD1(R)×g1+MD2(R)×g2 (1)

where (R) indicates that that data is R-component data. As a result, the output data is generated so that the layer 1 is displayed by 100% when the coincidence detection bit indicates that the image data does not coincide with the key color data, as shown in FIG. 25. The output data is generated so that the layer 1 is displayed by 5% and the layer 2 is displayed by 95% when the coincidence detection bit indicates that the image data coincides with the key color data and the key color 14 coincides with the image data.

The overlaid data is supplied to the display driver 40 through the driver I/F 180. The G-component output data OD(G) and the B-component output data OD(B) are similarly expressed by the equation (1).

3. Electronic Instrument

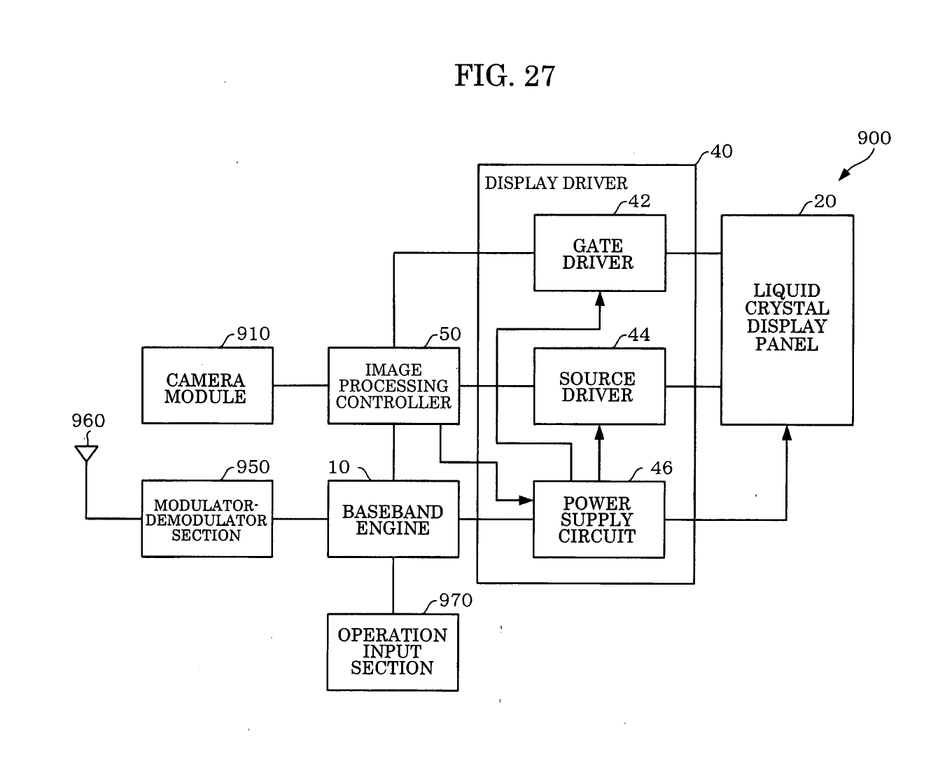

FIG. 27 is a block diagram showing a configuration example of a portable telephone as an electronic instrument according to one embodiment of the invention. In FIG. 27, the same sections as in FIG. 1 are indicated by the same symbols. Description of these sections is appropriately omitted.

A portable telephone 900 includes a camera module 910. The camera module 910 includes a CCD camera, and supplies data of an image captured using the CCD camera to the image processing controller 50 (image processing device) in a YUV format, for example.

The portable telephone 900 includes a liquid crystal display panel 20. The liquid crystal display panel 20 is driven by a display driver 40 (driver section). The liquid crystal display panel 20 includes a plurality of gate lines, a plurality of source lines, and a plurality of pixels.

The display driver 40 includes a gate driver 42, a source driver 44, and a power supply circuit 46. The gate driver 42 scans the gate lines of the liquid crystal display panel 20. The source driver 44 drives the source lines of the liquid crystal display panel 20 based on image data. The power supply circuit 46 generates voltages supplied to the gate driver 42, the source driver 44, and the liquid crystal display panel 20. The power supply circuit 46 is connected to the source driver 44 and the gate driver 42, and supplies drive power supply voltages to the source driver 44 and the gate driver 42. The power supply circuit 46 supplies a common electrode voltage Vcom to a common electrode of the liquid crystal display panel 20.

The image processing controller 50 is connected to the display driver 40, and supplies image data in an RGB format to the source driver 44.

The baseband engine 10 is connected to the image processing controller 50. The baseband engine 10 controls the image processing controller 50. The baseband engine 10 demodulates image data received via an antenna 960 using a modulator-demodulator section 950, and supplies the demodulated image data to the image processing controller 50. The image processing controller 50 causes the source driver 44 and the gate driver 42 to display an image on the liquid crystal display panel 20 based on the image data.

The baseband engine 10 modulates the image data generated by the camera module 910 using the modulator-demodulator section 950, and directs transmission of the modulated data to another communication device via the antenna 960.

The baseband engine 10 transmits and receives image data, captures an image using the camera module 910, and displays an image on the liquid crystal display panel 20 based on operation information from an operation input section 970.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. For example, the invention may be applied not only to drive the liquid crystal display panel, but also to drive an electroluminescent display device, a plasma display device, and the like.

Some of the requirements of any claim of the invention may be omitted from a dependent claim which depends on that claim. Some of the requirements of any independent claim of the invention may be allowed to depend on any other independent claim.

What is claimed is:

1. An image data decoding device that decodes compressed image data obtained by encoding image data using a lossy compression process, the image data being subjected to a key color process that extracts a pixel of a color that coincides with a key color, the image data decoding device comprising:
a decoding section that decompresses the compressed image data to decode the compressed image data; and
a decoded data comparison section that detects whether or not a color indicated by first decoded data obtained by the decoding section coincides with the key color,
when the decoded data comparison section has detected that the color indicated by the first decoded data coincides with the key color, the image data decoding device outputting second decoded data that differs from the first decoded data instead of the first decoded data.

2. The image data decoding device as defined in claim 1,
the image data decoding device further including a decoded data processing section that generates the second decoded data based on the first decoded data when the decoded data comparison section has detected that the color indicated by the first decoded data coincides with the key color,
when the first decoded data includes image data of one or more color components, the decoded data processing section generating the second decoded data by changing image data of at least one color component selected from the image data of the one or more color components.

3. The image data decoding device as defined in claim 2,
the decoded data processing section generating the second decoded data by reversing a least significant bit of image data of at least one color component selected from the image data of the one or more color components.

4. The image data decoding device as defined in claim 1,
the image data decoding device further including a key color code detection section that detects a key color code from compressed image data that includes the key color code and encoded data that is generated by the lossy compression process, the key color code being output corresponding to image data of a pixel of a color that coincides with the key color,
the image data decoding device outputting image data corresponding to a key color designated by the key color code as decoded data when the key color code detection section has detected the key color code, and outputting data decoded by the decoding section as the decoded data when the key color code detection section has not detected the key color code.

5. The image data decoding device as defined in claim 4,
the key color code including a key color identifier code that indicates that the color of the pixel is the key color, and a key color parameter that indicates the key color.

6. The image data decoding device as defined in claim 4,
image data of an input image corresponding to one scan line being divided into a plurality of blocks, and the encoded data being data that is obtained by compressing the image data of the input image corresponding to a block among the plurality of blocks; and
the decoding section decoding the encoded data on a block-by-block basis.

7. An image processing device that supplies image data to a driver section of a display panel, the image processing device comprising:
an image data encoding device that performs a lossy compression process on image data that is subjected to a key color process to generate encoded data;
a memory that stores the encoded data that has been encoded by the image data encoding device; and
the image data decoding device as defined in claim 1 that decodes the encoded data that has been stored in the memory.

8. The image processing device as defined in claim 7,
the image data encoding device including:
an encoding section that performs the lossy compression process on the image data to generate the encoded data; and
a key color comparison section that compares a color of the image data of the pixel with the key color,
the image data encoding device outputting the encoded data obtained by performing the lossy compression process on the image data when the color of the image data does not coincide with the key color, and outputting a predetermined key color code instead of the encoded data when the color of the image data coincides with the key color.

9. The image processing device as defined in claim 8,
the encoding section encoding the image data at a compression rate equal to or higher than a predetermined compression rate; and
a bit length of the key color code being equal to or less than a number of bits that maintains the predetermined compression rate.

10. The image processing device as defined in claim 9,
the key color code being adjusted so that the bit length of the key color code is equal to the number of bits that maintains the predetermined compression rate by inserting dummy data into a key color parameter.

11. The image processing device as defined in claim 8,
image data of an input image corresponding to one scan line being divided into a plurality of blocks, and the encoding section performing the lossy compression process on the image data on a block-by-block basis to generate the encoded data.

12. The image processing device as defined in claim 11,
the image processing device further including a rotation processing section that performs a rotation process, the rotation process generating an image by rotating the input image by a given angle with respect to a vertical direction of the input image,
the rotation processing section including one or more line buffers, each of the one or more line buffers storing the image data of the input image corresponding to one scan line; and
image data of the image that has been generated by the rotation process performed by the rotation processing section being supplied to the encoding section.

13. An electronic instrument comprising:
the image processing device as defined in claim 7;
a driver section, image data being supplied to the driver section from the image processing device; and
a display panel that is driven by the driver section.

14. An image data encoding device that encodes image data that is subjected to a key color process that extracts a pixel of a color that coincides with a key color, the image data encoding device comprising:
an encoding section that performs a lossy compression process on the image data to generate encoded data; and
a key color comparison section that compares a color of a pixel indicated by the image data with the key color,
the image data encoding device outputting the encoded data obtained by performing the lossy compression process on the image data when the color does not coincide with the key color, and outputting a predetermined key color code instead of the encoded data when the color coincides with the key color.

15. The image data encoding device as defined in claim 14,
the key color code including a key color identifier code that indicates that the color of the pixel is the key color, and a key color paraneter that indicates the key color.

16. The image data encoding device as defined in claim 14,
the encoding section encoding the image data at a compression rate equal to or higher than a predetermined compression rate; and
a bit length of the key color code being equal to or less than a number of bits that maintains the predetermined compression rate.

17. The image data encoding device as defined in claim 16,
the key color code being adjusted so that the bit length of the key color code is equal to the number of bits that maintains the predetermined compression rate by inserting dummy data into the key color parameter.

18. The image data encoding device as defined in claim 14,
image data of an input image corresponding to one scan line being divided into a plurality of blocks, and the encoding section performing the lossy compression process on the image data on a block-by-block basis to generate the encoded data.

19. The image data encoding device as defined in claim 18,
the image data encoding device further including a rotation processing section that performs a rotation process, the rotation process generating an image by rotating the input image by a given angle with respect to a vertical direction of the input image,
the rotation processing section including one or a plurality of line buffers, each of the one or a plurality of line buffers storing the input image of the input image corresponding to one scan line; and
image data of the image that has been generated by the rotation process performed by the rotation processing section being supplied to the encoding section.

20. An image data decoding device that decodes compressed image data obtained by encoding image data that is subjected to a key color process that extracts a pixel of a color that coincides with a key color, the image data decoding device comprising:
a key color code detection section that detects a key color code from compressed image data that includes a key color code and encoded data that is generated by a lossy compression process, the key color code being output corresponding to image data of a pixel of a color that coincides with the key color; and
a decoding section that decompresses the encoded data included in the compressed image data to decode the encoded data,
the image data decoding device outputting image data corresponding to a key color designated by the key color code as decoded data when the key color code detection section has detected the key color code, and outputting data decoded by the decoding section as the decoded data when the key color code detection section has not detected the key color code.
